(19) United States
(12) Patent Application Publication
(10) Pub. No.: US 2015/0269393 A1
(43) Pub. Date: Sep. 24, 2015

(54) SYSTEMS AND METHODS FOR SHARING DIGITAL CONTENT IN FRAGMENTS

(71) Applicant: YouSlide Development Inc., Delta (CA)

(72) Inventors: Scott Robert LAUDER, Delta (CA); Kristopher Grant SUTHERLAND, North Vancouver (CA); David James HUDSON, Fredericton (CA)

(21) Appl. No.: 14/664,782

(22) Filed: Mar. 20, 2015

Related U.S. Application Data
(60) Provisional application No. 61/968,921, filed on Mar. 21, 2014.

(51) Int. Cl. G06F 21/62

(52) U.S. Cl. CPC G06F 21/6245; G06F 21/6263

(57) ABSTRACT

The invention is directed to improved systems, methods, and media for sharing digital content through social media. More particularly, the invention provides for sharing digital content using fragments. In some embodiments, two users share digital content with one other, where each digital content being shared is obscured and overlaid by fragments. Each user will take a turn to select a fragment to be revealed from the digital content being shared, and both users continue revealing fragments until all fragments are revealed. The revealed digital content can be further updated from an obscured format to an unobscured format. The revealed digital content can be available for both users to view for a predetermined period before it is deleted or recalled.

### RELATED APPLICATIONS

This application claims priority to U.S. Provisional Patent Application No. 61/968,921, titled “Method for Sharing Images in Fragments,” which was filed on Mar. 21, 2014 and is incorporated herein in its entirety. This application relates to co-pending U.S. patent application Ser. No. ______ (Our Docket No.: 2211045.00121-US1), titled “Systems and Methods for Sharing Digital Content in Fragments,” which is filed on Mar. 20, 2015 and is incorporated by reference herein in its entirety.

### BACKGROUND OF THE INVENTION

1. Technical Field

This invention relates to the field of social media, and more particularly, to sharing digital content through social media.

2. Description of the Related Art

People commonly share digital content, such as images and documents, when they interact with one other through social media. People share digital content for various reasons, including, for example, to update families and friends about their lives, or to get to know one other better.

Traditionally, when two parties share digital content, they first agree on what digital content they plan to share, then one party initiates the sharing process by sharing his/her digital content, and then the other party completes the sharing process by sharing his/her digital content. There are, however, several problems related to this traditional approach.

First, one or both parties may not share the digital content that was agreed upon. For example, both parties may initially agree to share photographs of their respective self-portraits. After the first party sends his/her self-portrait, the second party could either (1) share a photograph that is not his/her self-portrait or (2) not share a photograph at all. By this time, it would be too late for the first party to cancel the digital content sharing process or to recall the digital content that has been shared by the first party.

Second, sometimes the first party may share abusive, insulting, or other inappropriate content with the second party. The second party may not know that the content is abusive or insulting until he/she sees it. As a result, the second party may not be able to cancel the content sharing process without first seeing the digital content.

Therefore, there is a need in the art to provide systems and methods for sharing digital content that overcome these and other deficiencies of the related art.

### SUMMARY

In accordance with the disclosed subject matter, systems, methods, and media are provided for sharing digital content in fragments.

The disclosed subject matter includes a method for sharing digital content in fragments. The method comprises: (a) receiving, at a first user device, a selection of a first digital content; (b) sending, at the first user device, the first digital content to a server or a second user device; (c) receiving, at the first user device, from the server or the second user device, a second digital content; (d) generating and displaying, at the first user device, a second digital content packet comprising: obscuring the second digital content to generate a second obscured digital content, and overlaying a screen comprising a second plurality of fragments, wherein the screen overlays on top of the second obscured digital content; (e) receiving, at the first user device, a selection of at least one fragment from (1) a first plurality of fragments associated with the first digital content from the server or the second user device, or (2) the second plurality of fragments, and in response: if the selection of the at least one fragment is from the first plurality of fragments from the server or the second user device, updating, at the first user device, the second digital content packet by removing at least one counterpart fragment from the second plurality of fragments to reveal at least one underlying portion of the second obscured digital content, and if the selection of the at least one fragment is from the second plurality of fragments, updating, at the first user device, the second digital content packet by removing the selected at least one fragment from the second plurality of fragments to reveal at least one underlying portion of the second obscured digital content; (f) repeating, at the first user device, step (e) until all of the second plurality of fragments are removed and the first user device receives an indication from the server or the second user device that all of the first plurality of fragments are removed; and (g) revealing the second digital content.

The disclosed subject matter includes an apparatus for sharing digital content in fragments, comprising: a memory that stores a data processing module; and a server configured to run the data processing module stored in the memory. The module is configured to (a) receive a selection of a first digital content; (b) send the first digital content to a server or a second user device; (c) receive a second digital content from the server or the second user device; (d) generate and display a second digital content packet comprising: a second obscured digital content that obscures the second digital content, and a screen comprising a second plurality of fragments, wherein the screen overlays on top of the second obscured digital content; (e) receive a selection of at least one fragment from (1) a first plurality of fragments associated with the first digital content from the server or the second user device, or (2) the second plurality of fragments, and in response: if the selection of the at least one fragment is from the first plurality of fragments from the server or the second user device, update the second digital content packet by removing at least one counterpart fragment from the second plurality of fragments to reveal at least one underlying portion of the second obscured digital content, and if the selection of the at least one fragment is from the second plurality of fragments, update the second digital content packet by removing the selected at least one fragment from the second plurality of fragments to reveal at least one underlying portion of the second obscured digital content; (f) repeat step (e) until (1) all of the second plurality of fragments are removed and (2) an indication is received from the server or the second user device that all of the first plurality of fragments are removed; and (g) reveal the second digital content.

The disclosed subject matter further includes a non-transitory computer readable medium. The non-transitory computer readable medium can include executable instructions operable to cause an apparatus to (a) receive a selection of a first digital content; (b) send the first digital content to a server or a second user device; (c) receive a second digital content from the server or the second user device; (d) generate and display a second digital content packet comprising: a second obscured digital content that obscures the second digital content, and a screen comprising a second plurality of fragments, wherein the screen overlays on top of the second obscured digital content; (e) receive a selection of at least one fragment from (1) a first plurality of fragments associated with the first digital content from the server or the second user device, or (2) the second plurality of fragments, and in response: if the selection of the at least one fragment is from the first plurality of fragments from the server or the second user device, update the second digital content packet by removing at least one counterpart fragment from the second plurality of fragments to reveal at least one underlying portion of the second obscured digital content, and if the selection of the at least one fragment is from the second plurality of fragments, update the second digital content packet by removing the selected at least one fragment from the second plurality of fragments to reveal at least one underlying portion of the second obscured digital content; (f) repeat step (e) until (1) all of the second plurality of fragments are removed and (2) an indication is received from the server or the second user device that all of the first plurality of fragments are removed; and (g) reveal the second digital content.

There has thus been outlined, rather broadly, the features of the disclosed subject matter in order that the detailed description thereof that follows may be better understood, and in order that the present contribution to the art may be better appreciated. There are, of course, additional features of the disclosed subject matter that will be described hereinafter and which will form the subject matter of the claims appended hereto.

In this respect, before explaining at least one embodiment of the disclosed subject matter in detail, it is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, systems, methods, and media for carrying out the several purposes of the disclosed subject matter. It is important, therefore, that the claims be regarded as including such equivalent constructions insofar as they do not depart from the spirit and scope of the disclosed subject matter.

These together with the other objects of the disclosed subject matter, along with the various features of novelty which characterize the disclosed subject matter, are pointed out with particularity in the claims annexed to and forming a part of this disclosure. For a better understanding of the disclosed subject matter, its operating advantages and the specific objects attained by its uses, reference should be had to the accompanying drawings and descriptive matter in which there are illustrated preferred embodiments of the disclosed subject matter.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 illustrates a diagram of a digital content sharing system in accordance with an embodiment of the disclosed subject matter.

FIGS. 2(a) and 2(b) illustrate a flow diagram demonstrating an operation of sharing digital content in fragments in accordance with an embodiment of the disclosed subject matter.

FIGS. 3(a) to 3(h) illustrate a set of exemplary displays on a sender's user device such as a smartphone, using a portrait orientation, in accordance with an embodiment of the disclosed subject matter.

FIGS. 4(a) to 4(h) illustrate a set of exemplary displays on a recipient's user device such as a computer in accordance with an embodiment of the disclosed subject matter.

FIGS. 5(a) to 5(h) illustrate a set of exemplary displays on a sender's user device such as a smartphone, using a landscape orientation, in accordance with an embodiment of the disclosed subject matter.

FIG. 6 illustrates an exemplary display where a plurality of fragments are arranged in a grid pattern on a user device in accordance with an embodiment of the disclosed subject matter.

FIG. 7 illustrates an exemplary display where a plurality of fragments are arranged in an interlocking pattern on a user device in accordance with an embodiment of the disclosed subject matter.

FIG. 8 illustrates an exemplary display where a plurality of fragments are arranged in a geometric pattern on a user device in accordance with an embodiment of the disclosed subject matter.

FIGS. 9(a) to 9(j) illustrate a set of exemplary displays of obscured digital content with different obscuring methods in accordance with an embodiment of the disclosed subject matter.

FIG. 10 illustrates an exemplary unilateral sharing process on a user device in accordance with an embodiment of the disclosed subject matter.

FIG. 11 is a block diagram of a server in accordance with an embodiment of the disclosed subject matter.

### DETAILED DESCRIPTION

In the following description, numerous specific details are set forth regarding the systems, methods and media of the disclosed subject matter and the environment in which such systems, methods and media may operate, etc., in order to provide a thorough understanding of the disclosed subject matter. It will be apparent to one skilled in the art, however, that the disclosed subject matter may be practiced without such specific details, and that certain features, which are well known in the art, are not described in detail in order to avoid complication of the disclosed subject matter. In addition, it will be understood that the examples provided below are exemplary, and that it is contemplated that there are other systems, methods and media that are within the scope of the disclosed subject matter.

The invention is directed to improved systems, methods, and media for sharing digital content through social media, websites, or other applications. More particularly, the invention provides for sharing digital content using fragments. When users share digital content in fragments, generally each digital content being shared is obscured and overlaid by fragments. Each user then takes a turn to select a fragment to be revealed from the digital content being shared until all fragments are revealed. The revealed digital content can then be updated from an obscured format to an unobscured format.

Sharing digital content in fragments overcomes the problems and deficiencies associated with the traditional prior art approach. In particular, the invention advantageously allows for two parties sharing digital content to agree on the content and portions of the content to share and, at any time, allows either party can cancel the digital content sharing process. Specifically, sharing digital content in fragments would ensure that if one party does not share the content that was agreed upon, then the other party can cancel the content sharing process at any time. For example, assume two parties are having a discussion through social media and agree to share images of their pets. If the first party sends a fragment of an image of his/her cat and the second party shares a fragment of an image that was not of his/her pet and/or appears to contain material deemed inappropriate by the first party, then the first party can cancel the digital content sharing process without seeing the entire image.

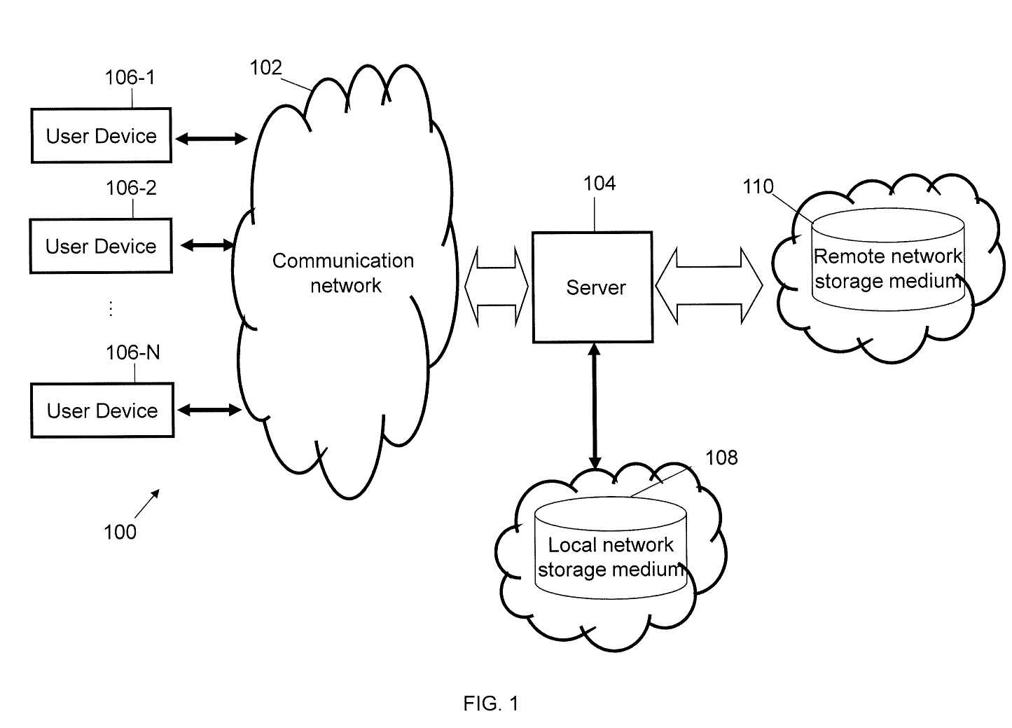

FIG. 1 illustrates a diagram of a digital content sharing system in accordance with an embodiment of the disclosed subject matter. The digital content sharing system 100 can include a communication network 102, a server 104, and at least one user device 106 (e.g., user device 106-1, 106-2, . . . , 106-N), a local network storage medium 108, and a remote network storage medium 110. The components described in the digital content sharing system 100 can be further broken down into more than one component and/or combined together in any suitable arrangement. Further, one or more components can be rearranged, changed, added, and/or removed. The terms “share” and “sharing” are used herein to refer to multilateral sharing, bilateral sharing, which can also refer to as exchanging, and unilateral sharing.

Each user device 106 can send digital content to, and receive digital content from, the server 104 over the communication network 102. Each user device 106 can be directly coupled to the server 104; alternatively, each user device 106 can be connected to server 104 via any other suitable device, communication network, or combination thereof. For example, each user device 106 can be coupled to the server 104 via one or more routers, switches, access points, and/or communication networks (as described below in connection with communication network 102). A user device 106 can include a desktop computer, a mobile computer, a tablet computer, a cellular device including a smartphone, or any other suitable computing system that is capable of performing computation. The server 104 can be a single server, or a network of servers, or a farm of servers in a data center. Digital content includes, without limitation, video, streaming video, images, photographs, documents, and any files with extension types including, without limitation, jpg, jpeg, jpeg2000, tiff, gif, bmp, png, wmv, rm, rmvb, asf, mp4, mpeg, and avi.

The communication network 102 can include a network or combination of networks that can accommodate private data communication. For example, the communication network 102 can include a local area network (LAN), a virtual private network (VPN) coupled to the LAN, a private cellular network, a private telephone network, a private computer network, a private packet switching network, a private line switching network, a private wide area network (WAN), a corporate network, or any number of private networks that can be referred to as an Intranet. Such networks may be implemented with any number of hardware and software components, transmission media and network protocols. FIG. 1 shows the communication network 102 as a single network; however, the communication network 102 can include multiple interconnected networks listed above.

The server 104 can be coupled to a network storage system. The network storage system can include two types of network storage devices: a local network storage medium 108 and a remote network storage medium 110. The local network storage medium 108 and the remote network storage medium 110 can each include at least one physical, non-transitory storage medium, flash memory, a magnetic disk drive, an optical drive, a programmable read-only memory (PROM), a read-only memory (ROM), or any other memory or combination of memories. The local network storage medium 108 and the remote network storage medium 110 can be part of the server 104 or can be separated from the server 104.

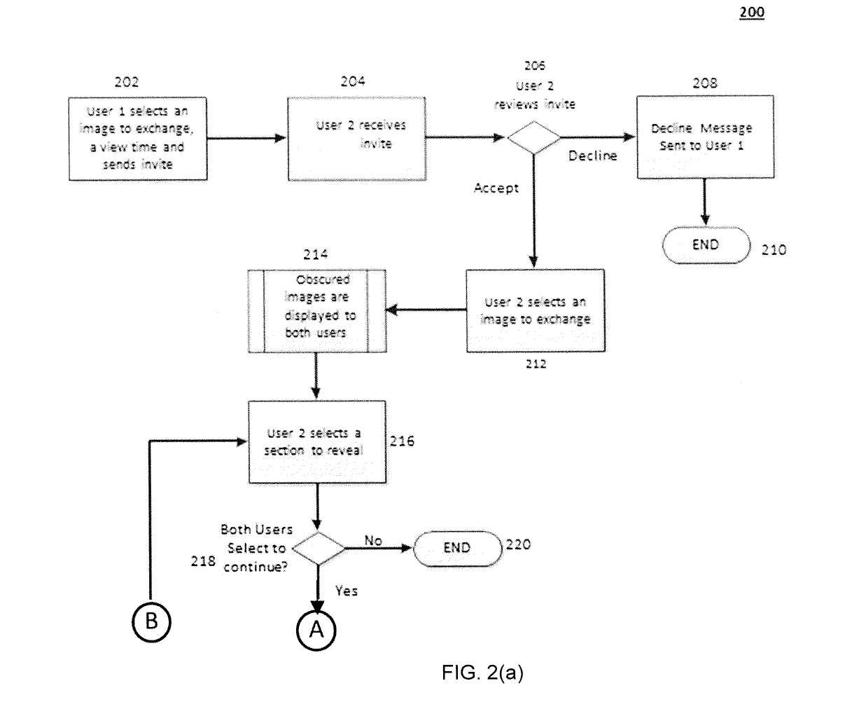

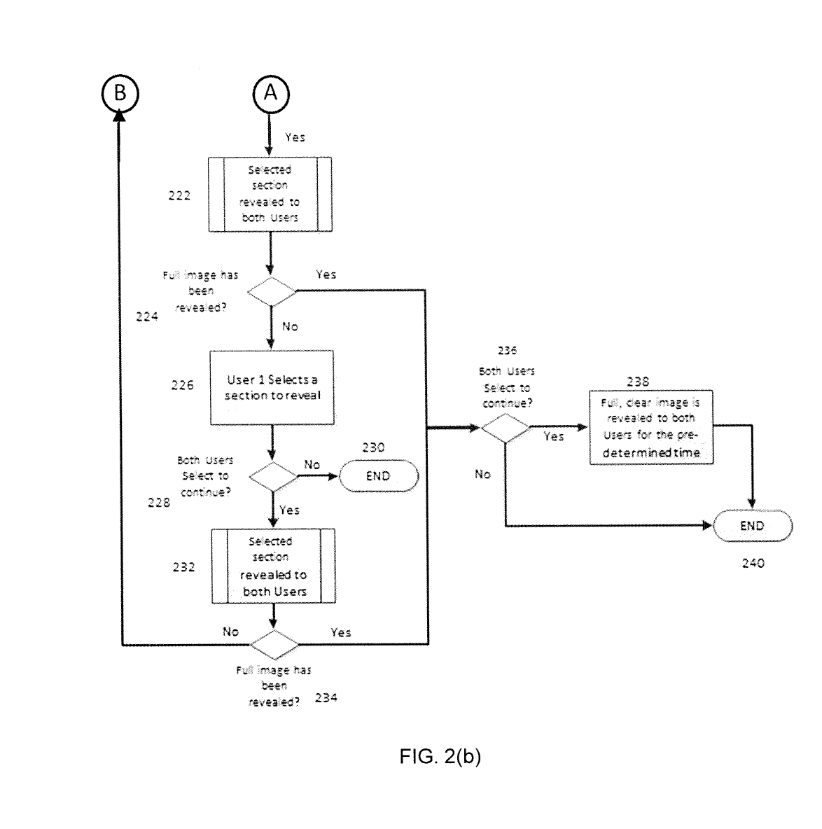

The digital sharing process disclosed in this invention can be implemented as part of social media or social network sites (e.g., Facebook, Twitter, Instagram, Tinder, or other social medial or social network sites). The digital sharing process disclosed in this invention can also be implemented as a separate application, and users can log into the separate application without any login credentials, through dedicated login credentials, or through other social media or social network accounts such as Facebook, Twitter, Instagram, or Tinder. FIGS. 2(a) and 2(b) illustrate a flow diagram illustrating a process 200 for sharing digital content in fragments in accordance with an embodiment of the disclosed subject matter. Process 200 begins at step 202 in which a first user at a first user device 106-1 initiates a digital content sharing operation by sending an invitation, which can be directed for to a second user at a second user device 106-2, to a server 104. In some embodiments, the first user can select a second user from the first user's contact list, where the contact list can include, without limitation, the first user's social media or social network account, the first user's contact information stored on the first user device 106-1 or other storage medium, or a contact list that the first user just created. In some embodiments, the first user can select a second user based on geographic location. For example, the first user can select a second user who is located within a certain specified distance of the first user. The distance can be predetermined by the application or can be specified by the first user (e.g., by specifying a region on any suitable mapping application, by entering a zip code, by entering a state or city, by specifying a radius within a certain mile or other distance). In some embodiments, the digital content sharing process can use GPS circuitry included in the first user device 106-1 to determine the location of the first user and the location of any other users and/or the first user's contacts. In some embodiments, the first user can select a second user who is using the same digital content sharing system, application, or software as the first user. In some embodiments, the first user can select a second user randomly through the server 104. In some embodiments, the first user can select to send the invitation to more than one second user.

Along with the invitation, the first user at the first user device 106-1 can select and send a first digital content to be shared with the second user to the server 104 or the second user device 106-2. In some embodiments, the first digital content can include images or videos that are captured in real time after the first user initiated process 200. In some embodiments, the first digital content can include images or videos that are stored in the first user device 106-1 or other storage medium. In some embodiments, the first user or the server 104 can select a digital content expiration time, which indicates how long both users can view the shared digital content shared before it is deleted or recalled by the server 104 or user devices. As non-limiting examples, the digital content expiration time can be 3 seconds, 8 seconds, 1 minute, or any other duration.

In step 204, the server 104 sends the invitation from the first user device 106-1 to the second user at a second user device 106-2. In some embodiments, the second user device 106-2 can alert the second user that an invitation has been received for sharing digital content. As non-limiting examples, the second user device 106-2 can alert the second user by vibrating, beeping, ringing, popping up a message on the display of the second user device 106-2, and displaying a symbol on the digital content sharing application.

In step 206, the second user at the second user device 106-2 reviews the invitation and decides either to accept or decline the invitation. If the second user declines the invitation from the first user, process 200 moves to step 208 where the second user device 106-2 sends a message to the first user device 106-1 via the server 104 indicating that the second user has declined the sharing of the digital content. Process 200 then ends at step 210, and the second user device 106-2 will not receive the first digital content sent by the first user device 106-1.

If the second user accepts the invitation from the first user, process 200 moves to step 212 where the second user at the second user device 106-2 can then select and send a second digital content to be shared with the first user to the server 104 or the first user device 106-1. In some embodiments, the second digital content can include images or videos that are captured in real time by the second user. In some embodiments, the second digital content can include images or videos that are stored in the second user device 106-2 or other storage medium. In some embodiments, the second user or server 104 can select a digital content expiration time, which indicates how long both users can view the shared digital content shared before it is deleted or recalled by the server 104 or the user devices.

Next, at step 214, the server 104 generates a first digital content packet, which includes an obscured first digital content that is overlaid by a screen comprising a first plurality of fragments. The server 104 also generates a second digital content packet, which includes an obscured second digital content that is overlaid by a screen comprising a second plurality of fragments. Throughout this application, the obscured first digital content refers to the first digital content in an obscured format, and the obscured second digital content refers to the second digital content in an obscured format. The server 104 then sends the first image packet to the second user device 106-2 for display and the second image packet to the first user device 106-1 for display. The digital content can be obscured through any suitable obscuring method or combination of methods, including, without limitation, blurring, pixelation, blacking out, graying out, blending, overlaying with another image, changing opacity level, adding noise, adding obscuring effect, changing brightness, or other suitable obscuring method. Either user or the server 104 can select one or more obscuring methods. In some embodiments, the overlaying screen can comprise any suitable number of fragments (e.g., 2, 3, 4, 7, or 10). In some embodiments, the first plurality of fragments and the second plurality of fragments can have a same number of fragments. In some embodiments, the first plurality of fragments and the second plurality of fragments can have a different number of fragments. Further, the overlaying screen can comprise a plurality of fragments arranged in different patterns. For example, the overlaying screen can comprise a plurality of fragments arranged in adjacent rectangles, a grid pattern, an interlocking or puzzle pattern, or any other suitable geometric patterns. In some embodiments, the first plurality of fragments and the second plurality of fragments can be arranged in a same pattern. In some embodiments, the first plurality of fragments and the second plurality of fragments can be arranged in different patterns. Either users or the server 104 can select the number of fragments and the arrangement pattern of the fragments.

In some embodiments at step 214, the first user device 106-1, rather than the server 104, (1) generates a first digital content packet, which includes an obscured first digital content that is overlaid by a screen comprising a first plurality of fragments, and (2) sends the first digital content packet to the server 104. In the same embodiments, the second user device 106-2, rather than the server 104, (1) generates a second digital content packet, which includes an obscured second digital content that is overlaid by a screen comprising a second plurality of fragments, and (2) sends the second digital content packet to the server 104. The server 104 then sends the first image packet to the second user device 106-2 for display and the second image packet to the first user device 106-1 for display.

In some embodiments at step 214, the first user device 106-1 receives the second digital content from the server 104 or the second user device 106-2, and second user device 106-2 receives the first digital content from the server 104 or the first user device 106-1. In some embodiments, the first user device 106-1 may have received the second digital content from the server 104 or the second user device 106-2 at an earlier step, and the second user device 106-1 may have received the first digital content from the server 104 or the first user device 106-1 at an earlier step. In the same embodiments, the second user device 106-2, rather than the server 104 or the first user device 106-1, generates and displays a first digital content packet, which includes an obscured first digital content that is overlaid by a screen comprising a first plurality of fragments. In the same embodiments, the first user device 106-1, rather than the server 104 or the second user device 106-2, generates and displays a second digital content packet, which includes an obscured second digital content that is overlaid by a screen comprising a second plurality of fragments.

In step 216, the second user selects one of the first plurality of fragments from the second user device 106-2. The server 104 receives the second user's selection from the second user device 106-2 and, in response, updates the first digital content packet by removing the one of the first plurality of fragments to reveal an underlying portion of the first obscured digital content. In some embodiments, the server 104 also automatically updates the second digital content packet by removing one counterpart fragment of the second plurality of fragments to reveal an underlying portion of the second obscured digital content. In some embodiments, the counterpart fragment of the second plurality of fragments has a symmetric, similar, or different location and/or size as the one of the first plurality of fragments selected by the second user. As an example, if the second user selects to remove a leftmost fragment of the first digital content packet, the server 104 can also remove a counterpart leftmost fragment of the second digital content packet. In some embodiments, the server 104 does not automatically update the second digital content packet for the first user after the selection of the second user. Instead, the first user may need to select a counterpart fragment of the second plurality of fragments: the server 104 receives the first user's selection from the first user device 106-1 and, in response, updates the second digital content packet by removing the counterpart fragment of the second plurality of fragments to reveal an underlying portion of the second obscured digital content. Users can indicate their selection of fragments by touching user devices through any suitable gestures. As an example, users can select a particular fragment by sliding up, down, left, or right on that particular fragment. As another example, users can select a particular fragment by clicking, tapping, or double tapping that particular fragment. In some embodiments, each user can select to remove more than one fragment at the same time. Step 216 is described in the context of the second user selecting one of the first plurality of fragments from the second user device 106-2; however, in an alternative embodiment step 216 can describe the first user selecting one of the second plurality of fragments from the first user device 106-1. That is, the roles of the first user and the second user can be reversed.

In some embodiments at step 216, the second user selects one of the first plurality of fragments from the second user device 106-2. The second user device 106-2, rather than the server 104, updates the first digital content packet by removing the one of the first plurality of fragments to reveal an underlying portion of the first obscured digital content. In some embodiments, the second user device 106-2 then sends the selection information to the server 104 or the first user device 106-2. In some embodiments, the first user device 106-1 receives the second user's selection from the second user device 106-2 or the server 104 and automatically updates the second digital content packet by removing one counterpart fragment of the second plurality of fragments to reveal an underlying portion of the second obscured digital content. In some embodiments, the counterpart fragment of the second plurality of fragments has a symmetric, similar, or different location and/or size as the one of the first plurality of fragments selected by the second user. As an example, if the second user selects to remove a leftmost fragment of the first digital content packet at the second user device 106-2, the first user device 106-1 can also remove a counterpart leftmost fragment of the second digital content packet. In some embodiments, the first user device 106-1 does not automatically update the second digital content packet for the first user after the selection of the second user. Instead, the first user may need to select a counterpart fragment of the second plurality of fragments: the first user device 106-1 then updates the second digital content packet by removing the counterpart fragment of the second plurality of fragments to reveal an underlying portion of the second obscured digital content. In step 216, if the first user device 106-1 updates the second digital content packet, then the first user device 106-1 holds and does not display the updated second digital content packet for the first user in step 216. Also in step 216, if the second user device 106-2 updates the first digital content packet, then the second user device 106-2 holds and does not display the updated first digital content packet for the second user in step 216.

In step 218, the server 104 checks whether at least one of the first user and the second user selects to cancel the process 200. In some embodiments at step 218, the first user device 106-1 checks whether the first user selects to cancel the process 200, and the second user device 106-2 checks whether the second user selects to cancel the process 200. If no user selects to cancel the digital content sharing process, process 200 proceeds to step 222. In some embodiments, both users need to affirmatively select to continue for process 200 to proceed to step 222. If at least one user selects to cancel the digital content sharing process, process 200 ends in step 220. In step 220, the server 104 can further send a cancellation notification to both the first user at the first user device 106-1 and the second user at the second user device 106-2. In some embodiments, the user or users who selects to cancel process 200 can have the option to send a message to the other user along with the cancellation notification. In some embodiments, the user or users who selects to cancel process 200 can have the option to send the other user a new request for sharing digital content.

In step 222, the server 104 sends the updated first digital content packet to the second user device 106-2 and the updated second digital content packet to the first user device 106-1. As illustrated in step 216, the updated digital content packets can reveal at least one portion of the obscured digital content that was covered by one or more fragments that have been selected for removal. In some embodiments, the revealed portion of the obscured digital content can be displayed in its original unobscured format for a period of time. The period of time can be selected by the users or the server 104.

In some embodiments in step 222, the first user device 106-1 has already updated the second digital content packet in step 216, and the second user device 106-2 has already updated the first digital content packet in step 216. The first user device 106-1 then displays the updated second digital content packet, and the second user device 106-2 then displays the updated first digital content packet.

In step 224, the server 104 determines whether all of the first plurality of fragments and all of the second plurality of fragments have been removed. In some embodiments at step 224, the first user device 106-1 checks whether all of the second plurality of fragments have been removed, and the second user device 106-2 checks whether all of the first plurality of fragments have been removed. If all of the first plurality of fragments and all of the second plurality of fragments have been removed, process 200 proceeds to step 236; otherwise, process 200 proceeds to step 226.

In step 226, the first user selects another one of the second plurality of fragments from the first user device 106-1. The server 104 receives the first user's selection from the first user device 106-1 and, in response, updates the second digital content packet by removing the another one of the second plurality of fragments to reveal an underlying portion of the second obscured digital content. In some embodiments, the server 104 also automatically updates the first digital content packet by removing another counterpart fragment of the first plurality of fragments to reveal an underlying portion of the first obscured digital content. In some embodiments, the another counterpart fragment of the first plurality of fragments has a symmetric, similar, or different location and/or size as the another one of the second plurality of fragments selected by the first user. As an example, if the first user selects to remove a rightmost fragment of the second digital content packet, the server 104 can also remove a counterpart rightmost fragment of the first digital content packet. In some embodiments, the server 104 does not automatically update the first digital content packet for the second user after the selection of the first user. Instead, the second user may need to select another counterpart fragment of the first plurality of fragments: the server 104 receives the second user's selection from the second user device 106-2 and, in response, updates the first digital content packet by removing the another counterpart fragment of the first plurality of fragments to reveal an underlying portion of the first obscured digital content. Users can indicate their selection of fragments by touching user devices through any suitable gestures. As an example, users can select a particular fragment by sliding up, down, left, or right on that particular fragment. As another example, users can select a particular fragment by clicking, tapping, or double tapping that particular fragment. In some embodiments, each user can select to remove more than one fragment at the same time. Step 226 is described in the context of the first user selecting another one of the second plurality of fragments from the first user device 106-1; however, in an alternative embodiment step 226 can describe the second user selecting another one of the first plurality of fragments from the second user device 106-2. That is, the roles of the first user and the second user can be reversed.

In some embodiments in step 226, the first user selects another one of the second plurality of fragments from the first user device 106-1. The first user device 106-1, rather than the server 104, updates the second digital content packet by removing the another one of the second plurality of fragments to reveal an underlying portion of the second obscured digital content. In some embodiments, the first user device 106-1 then sends the selection information to the server 104 or the second user device 106-2. In some embodiments, the second user device 106-2 receives the first user's selection from the first user device 106-1 or the server 104 and automatically updates the first digital content packet by removing another counterpart fragment of the first plurality of fragments to reveal an underlying portion of the first obscured digital content. In some embodiments, the another counterpart fragment of the first plurality of fragments has a symmetric, similar, or different location and/or size as the another one of the second plurality of fragments selected by the first user. As an example, if the first user selects to remove a rightmost fragment of the second digital content packet, the second user device 106-2 can also remove a counterpart rightmost fragment of the first digital content packet. In some embodiments, the second user device 106-2 does not automatically update the first digital content packet for the second user after the selection of the first user. Instead, the second user may need to select another counterpart fragment of the first plurality of fragments: the second user device 106-2 then updates the first digital content packet by removing the another counterpart fragment of the first plurality of fragments to reveal an underlying portion of the first obscured digital content. In step 226, if the first user device 106-1 updates the second digital content packet, then the first user device 106-1 holds and does not display the updated second digital content packet for the first user in step 226. Also in step 226, if the second user device 106-2 updates the first digital content packet, then the second user device 106-2 holds and does not display the updated first digital content packet for the second user in step 226.

In step 228, the server 104 checks whether at least one of the first user and the second user selects to cancel the process 200. In some embodiments, the first user device 106-1, rather than the server 104, checks whether the first user selects to cancel the process 200, and the second user device 106-2, rather than the server 104, checks whether the second user selects to cancel the process 200. If no user selects to cancel the digital content sharing process, process 200 proceeds to step 232. In some embodiments, both users need to affirmatively select to continue for process 200 to proceed to step 232. If at least one user selects to cancel the digital content sharing process, process 200 ends in step 230. In step 230, the server 104 can further send a cancellation notification to both the first user at the first user device 106-1 and the second user at the second user device 106-2. In some embodiments, the user or users who selects to cancel process 200 can have the option to send a message to the other user along with the cancellation notification. In some embodiments, the user or users who selects to cancel process 200 can have the option to send the other user a new request for sharing digital content.

In step 232, the server 104 sends the updated first digital content packet to the second user device 106-2 and the updated second digital content packet to the first user device 106-1. As illustrated in step 226, the updated digital content packets can reveal at least another portion of the obscured digital content that was covered by one or more fragments that have been selected for removal. In some embodiments, the revealed portion of the obscured digital content can be displayed in its original unobscured format for a period of time. The period of time can be selected by the users or the server 104.

In some embodiments in step 232, the first user device 106-1 has already updated the second digital content packet in step 226, and the second user device 106-2 has already updated the first digital content packet in step 226. The first user device 106-1 then displays the updated second digital content packet, and the second user device 106-2 then displays the updated first digital content packet.

In step 234, the server 104 determines whether all of the first plurality of fragments and all of the second plurality of fragments have been removed. In some embodiments, the first user device 106-1, rather than the server 104, determines whether all of the first plurality of fragments have been removed, and the second user device 106-2, rather than the server 104, determines whether all of the second plurality of fragments have been removed. If all of the first plurality of fragments and all of the second plurality of fragments have been removed, process 200 proceeds to step 236; otherwise, process 200 returns to step 216.

In step 236, the server 104 checks whether at least one of the first user and the second user selects to cancel the process 200. In some embodiments, the first user device 106-1, rather than the server 104, checks whether the first user selects to cancel the process 200, and the second user device 106-2, rather than the server 104, checks whether the second user selects to cancel the process 200. If no user selects to cancel the digital content sharing process, process 200 proceeds to step 238. In some embodiments, both users need to affirmatively select to continue for process 200 to proceed to step 238. If at least one user selects to cancel the digital content sharing process, process 200 ends in step 240. In step 240, the server 104 can further send a cancellation notification to both the first user at the first user device 106-1 and the second user at the second user device 106-2. In some embodiments, the user or users who selects to cancel process 200 can have the option to send a message to the other user along with the cancellation notification. In some embodiments, the user or users who selects to cancel process 200 can have the option to send the other user a new request for sharing digital content.

In step 238, the server 104 sends the unobscured first digital content to the second user device 106-2 and the unobscured second image to the first user device 106-1. In some embodiments in step 238, the first user device 106-1 has already received the second digital content at step 238 or an earlier step, and the second user device 106-2 has already received the first digital content at step 238 or an earlier step. The first user device 106-1 then displays the second digital content, and the second user device 106-2 then displays the first digital content. In some embodiments, the unobscured digital content can only be viewed by both users for a predetermined period of time before the digital content is deleted or recalled by the server 104 or the user devices. The period of time can be an expiration time selected by the first user in step 202, by the second user in step 212, or determined by the server 104. In some embodiments, when an expiration time is not set, the first user can save the shared second digital content to the first user device 106-1 or other storage medium, and/or the second user can save the shared first digital content to the second user device 106-2 or other storage medium. The process then ends at step 240.

Process 200 can be modified by, for example, having steps rearranged, changed, added, and/or removed. As an alternative embodiment, step 216 and step 226 can be swapped. In that alternative embodiment, the first user selects to remove one of the second plurality of fragments before the second user selects to remove another one of the first plurality of fragments. In some embodiments, the server 104 or user devices can dynamically obscure the first and/or the second digital content through different obscuring methods along the process 200. For example, the server 104 or user devices can, in step 222, display all revealed portions of the obscured second digital content in one obscuring manner (e.g., blurring), and, in step 232, reveal all revealed portions of the obscured second digital content in another obscuring manner (e.g., such as blending). In some embodiments, users can select to cancel the process 200 at any step. In some embodiments, one or more steps can be skipped or bypassed. As an example, step 216 can be skipped, and the process 200 can proceed directly from step 216 to step 222. As another example, step 228 can be skipped, and the process 200 can proceed directly from step 216 to step 232. As described earlier, the first digital content packet can be generated by the first user device 106-1, the second user device 106-2, or the server 104. The first digital content packet can be received and/or updated by the first user device 106-1, the second user device 106-2, or the server 104. The second digital content packet can be generated by the first user device 106-1, the second user device 106-2, or the server 104. The second digital content packet can be received and/or updated by the first user device 106-1, the second user device 106-2, or the server 104.

In some embodiments, process 200 can be exercised by the first and the second users while they are using their user devices for other activities, such as chatting, messaging/texting, calling, gaming, interacting with social media applications, or interacting with other applications.

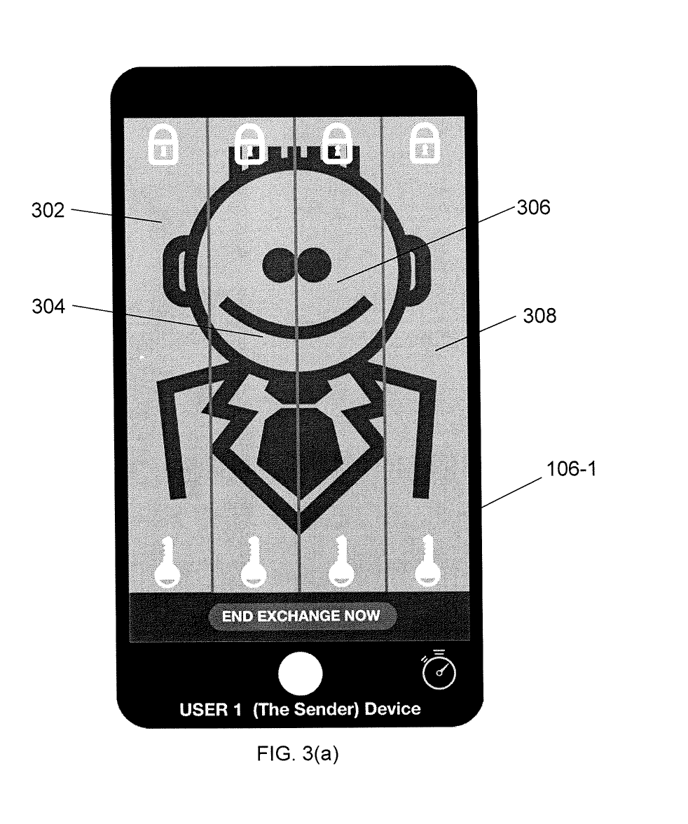

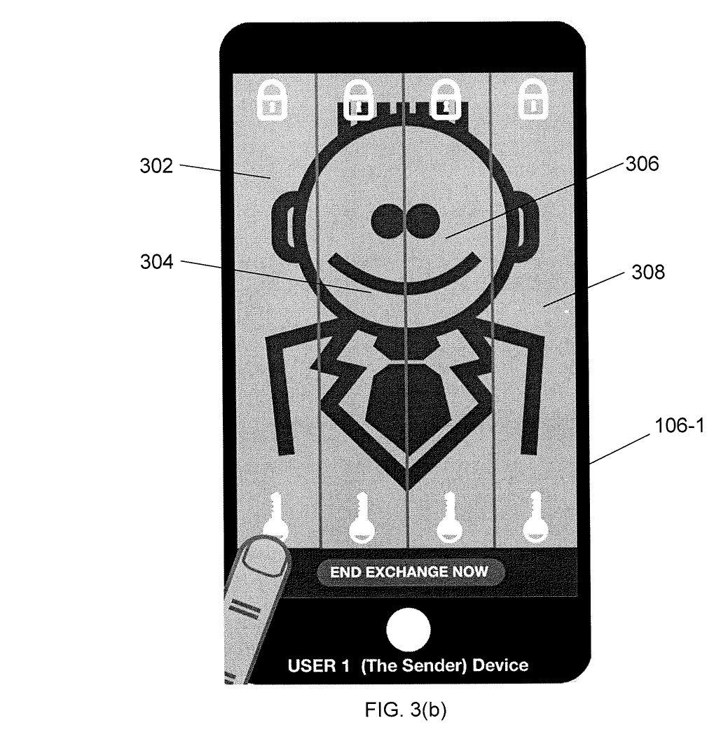

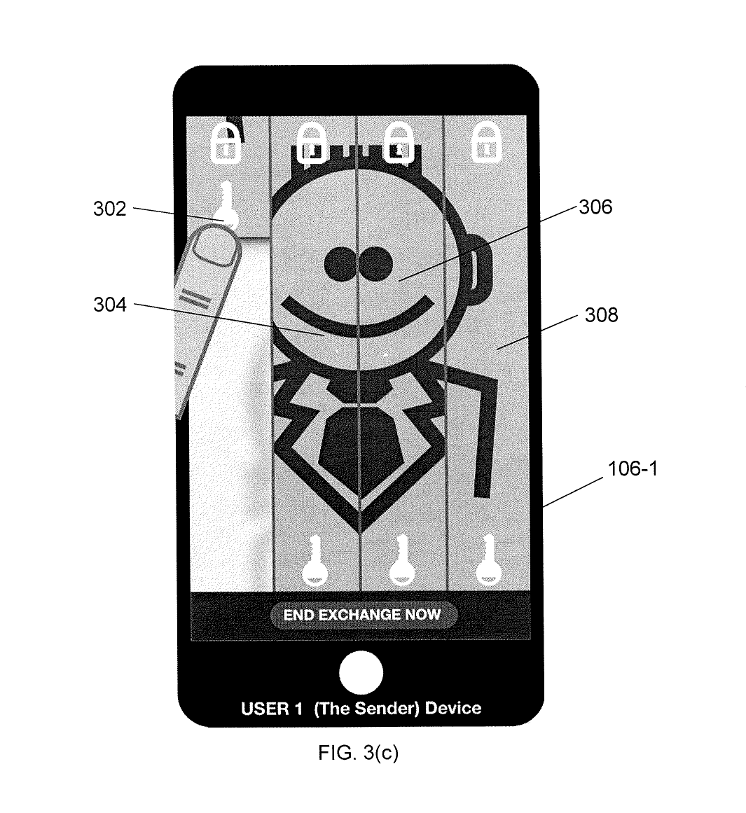

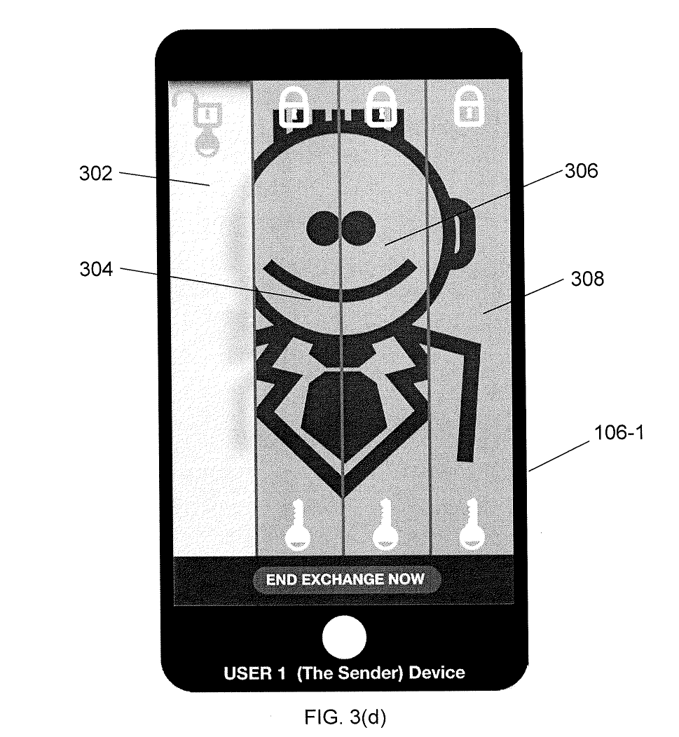

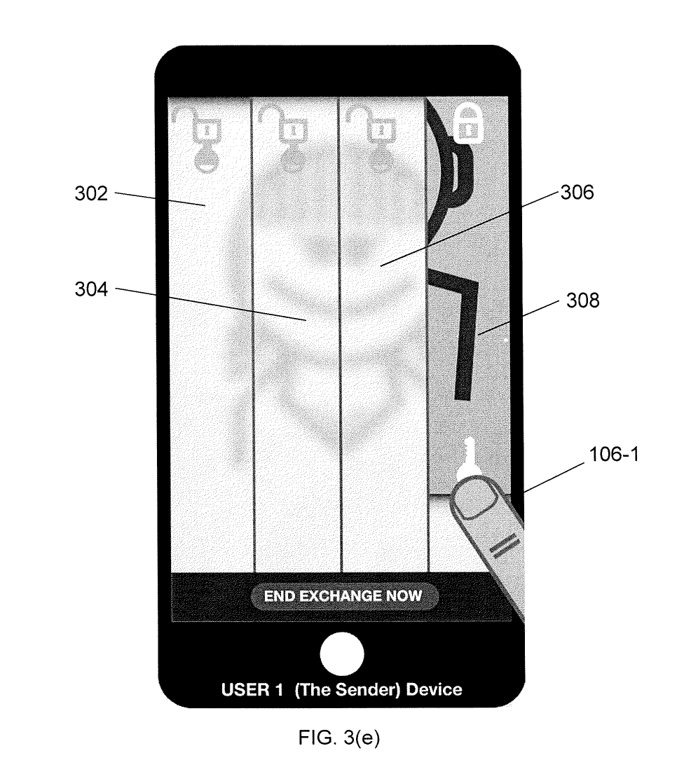

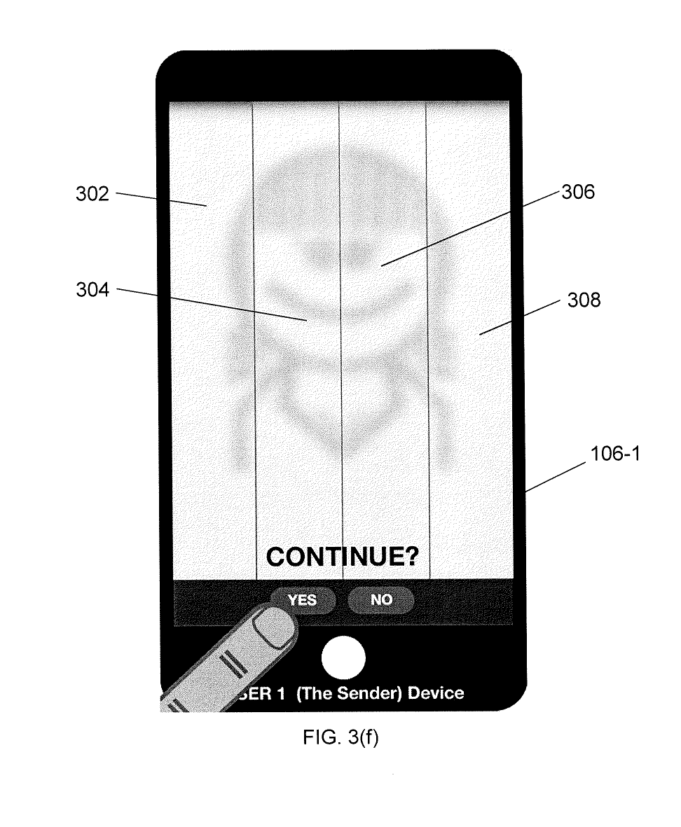

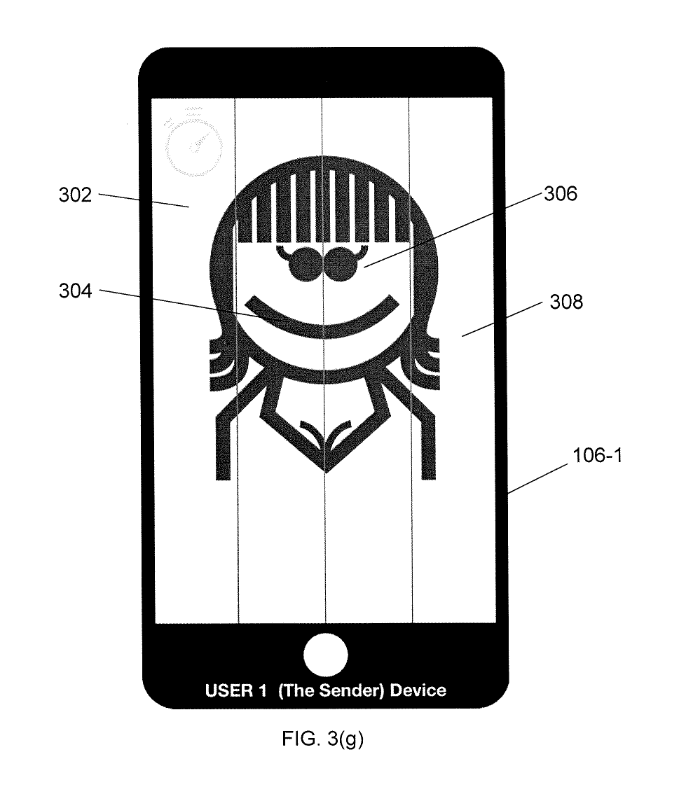

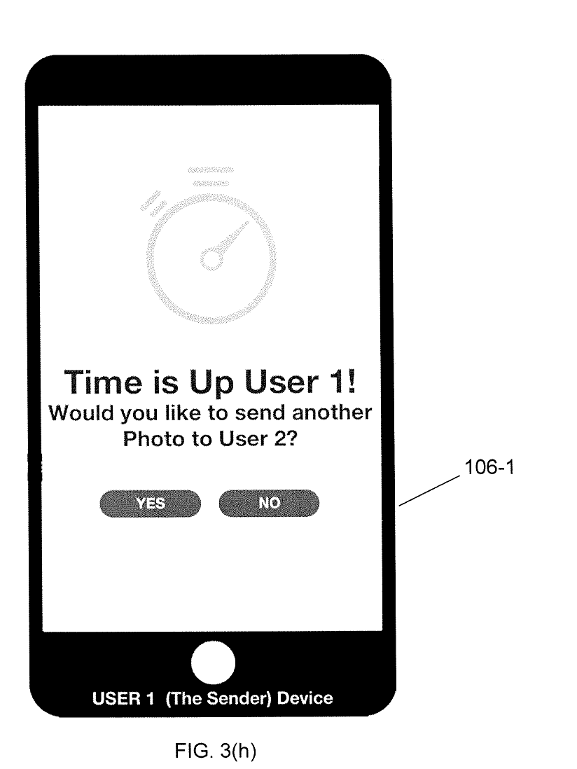

FIGS. 3(a) to 3(h) illustrate a set of exemplary displays on a first user device 106-1 in accordance with an embodiment of the disclosed subject matter, where the first user device 106-1 is a cellular phone and the displays are in a portrait orientation. FIG. 3(a) illustrates an exemplary display that shows a screen on the first user device 106-1 comprising four fragments, 302, 304, 306, and 308, in an adjacent rectangular arrangement from left to right, where the screen can show various kinds of digital content, including the first digital content that the first user intends to share with the second user and the second digital content that the first user receives from the second user. In some embodiments, the four fragments, 302, 304, 306, and 308 can be in an adjacent rectangular arrangement from top to bottom. Under the four fragments is an obscured version of the second digital content sent by the second user at the second user device 106-2. The display also illustrates that, in some embodiments, the user may select a digital content expiration time, by selecting the clock symbol located in the bottom right corner. In some embodiments, the first user can select a different numbers of fragments and/or different arrangements of fragments for display on the first user device 106-1. In some embodiments, the server 104 can select, on a predetermined or random basis, different numbers of fragments and/or different arrangements of fragments for display on the first user device 106-1.

FIGS. 3(b) to 3(d) illustrate an example of how the first user can select to remove a fragment on the screen so that the first user can see a portion of the underlying obscured second digital content. Specifically, FIG. 3(b) illustrates that the first user selects to remove the leftmost fragment 302 on the screen. FIG. 3(c) illustrates that the first user indicates the selection by sliding up the leftmost fragment 302. FIG. 3(d) illustrates that after the leftmost fragment 302 is removed, a portion of the underlying obscured second digital content is revealed. In an alternative embodiment, when the first user selects to remove a fragment displayed on the screen of the first user device 106-1, a counterpart fragment displayed on the screen of a second user device 106-2 can also be removed. For example, in that alternative embodiment, when the first user removes the leftmost fragment 302 displayed on the screen of the first user device 106-1 to see a portion of the underlying obscured second digital content, a counterpart leftmost fragment displayed on the screen of the second user device 106-2 can also be removed so that the second user can see a portion of underlying obscured first digital content. Further, although FIGS. 3(b) to 3(d) illustrate that the first user indicates the selection of a fragment by sliding up the fragment, other methods of indication can also be used in some embodiments, such as sliding down, left, right, clicking, tapping, or double tapping a selected one or more fragments.

FIG. 3(e) illustrates that the first user has removed three (i.e., fragments 302, 304, and 306) out of fragments and is going to remove the last fragment 208, which is a rightmost fragment displayed on the screen of the first user device 106-1.

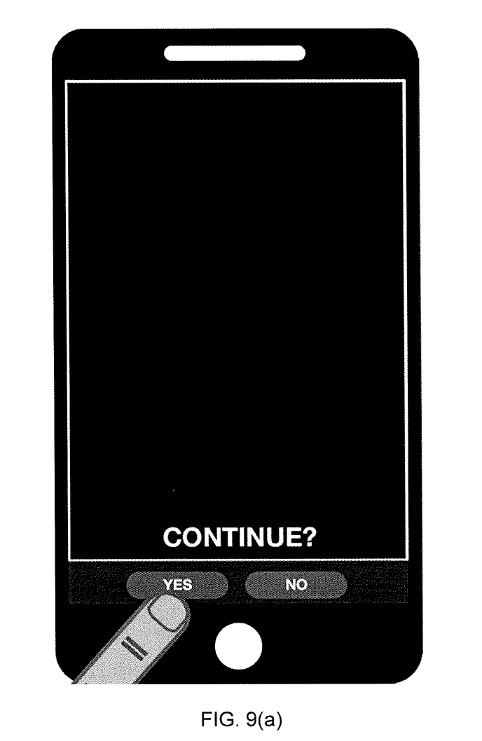

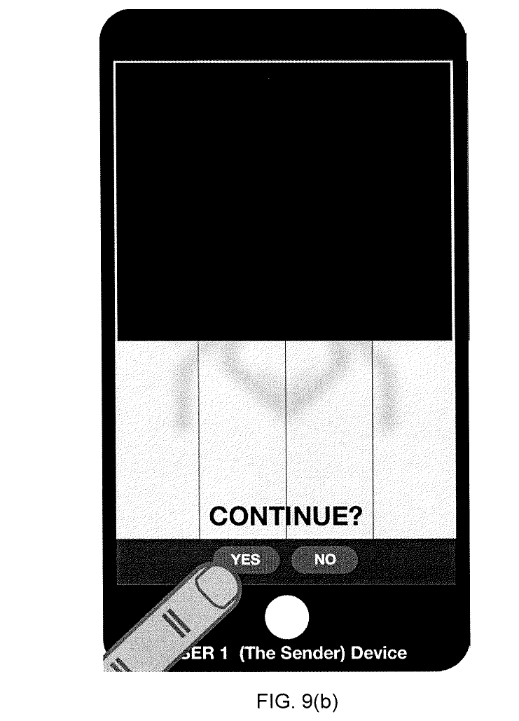

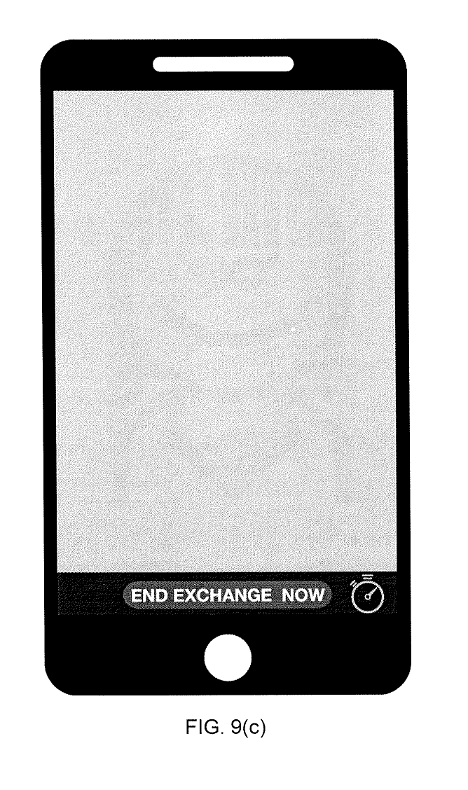

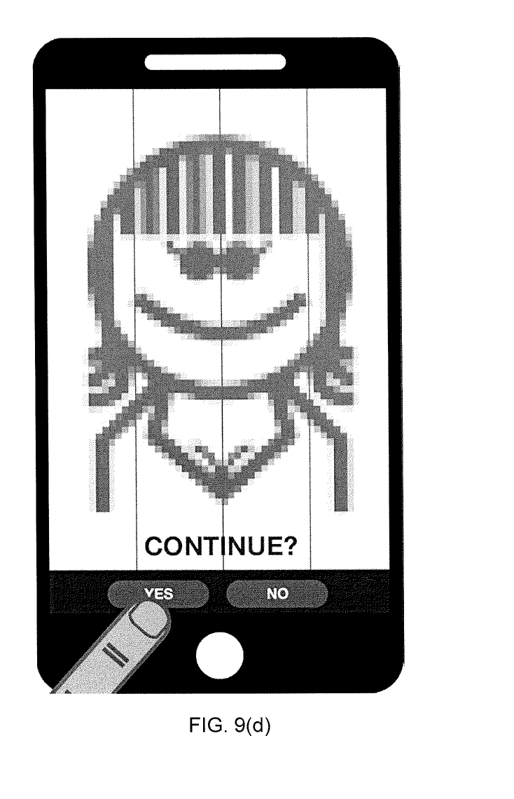

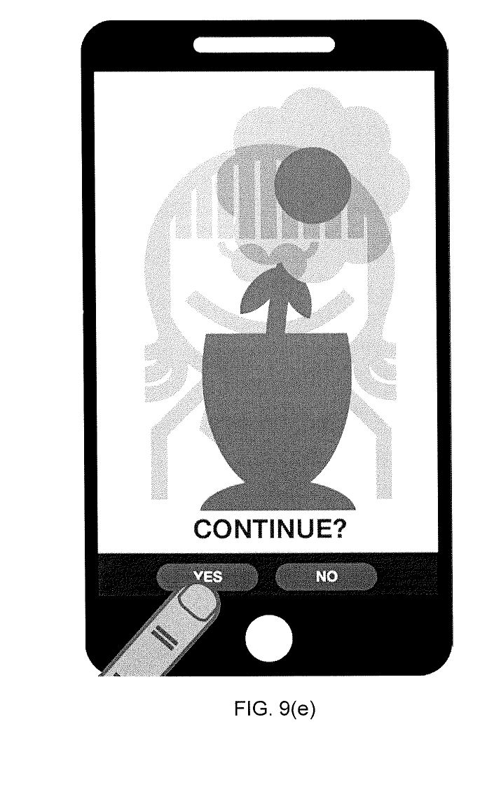

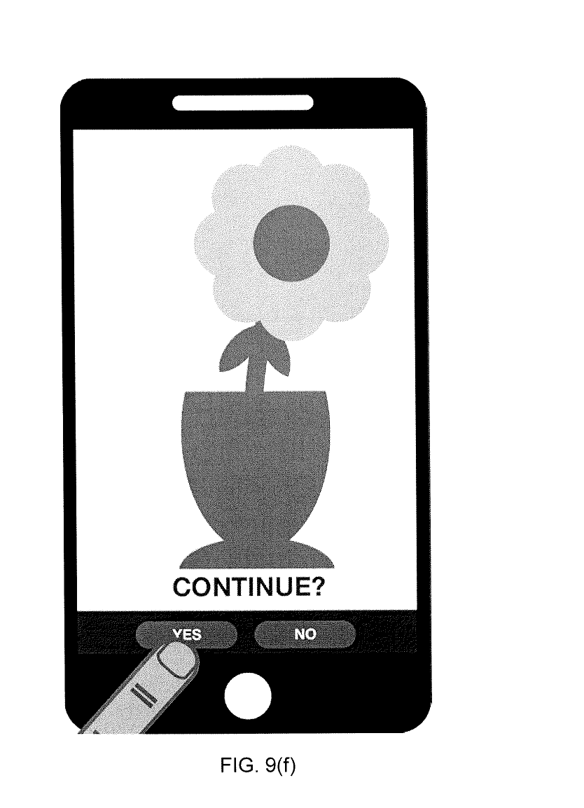

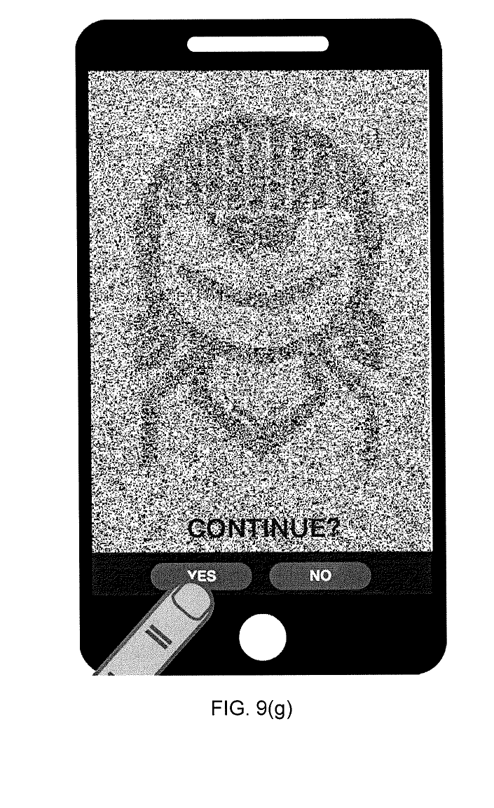

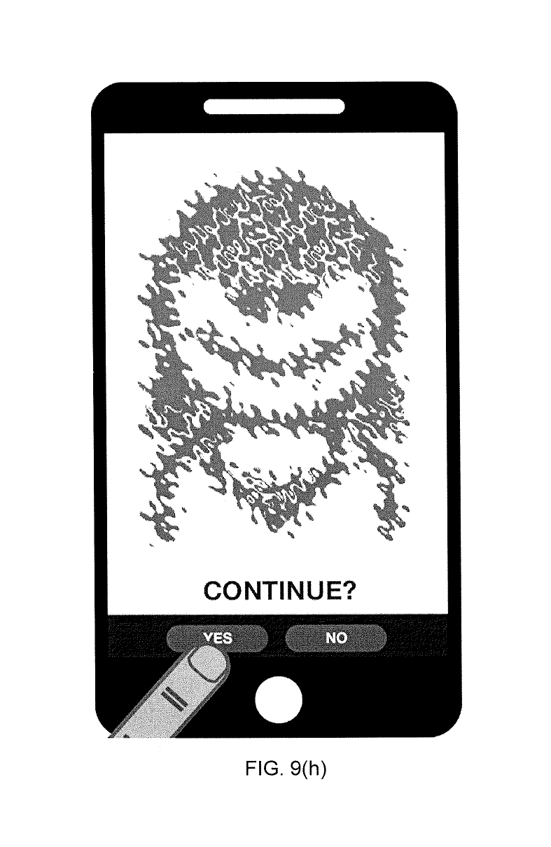

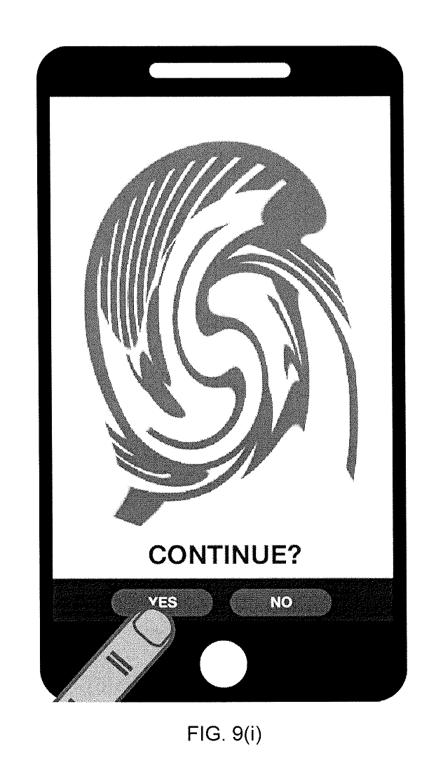

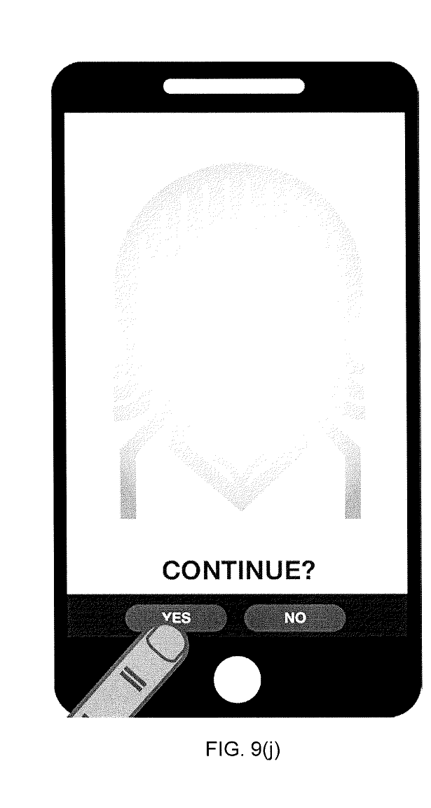

FIG. 3(f) illustrates that the first user has removed all four fragments 302, 304, 306, and 308 displayed on the screen of the first user device 106-1, and the whole obscured second digital content is revealed. In this embodiment, the second digital content is obscured through blurring. Other obscuring methods can also be used, such as illustrated by FIGS. 9(a) to 9(j).

FIG. 3(g) illustrates that the original second digital content is displayed on the first user device 106-1.

FIG. 3(h) illustrates that, in some embodiments, the original second digital content can only be viewed for a predetermined period of time that was selected by the users or the server 104. After this expiration time is reached, the original second digital content can be recalled or deleted by the server 104 or the user devices. In some embodiments, the first user can be prompted to initiate another digital content sharing process. Further, as illustrated by FIGS. 3(a) to 3(f), in some embodiments the first user can choose to end the digital content process at any time.

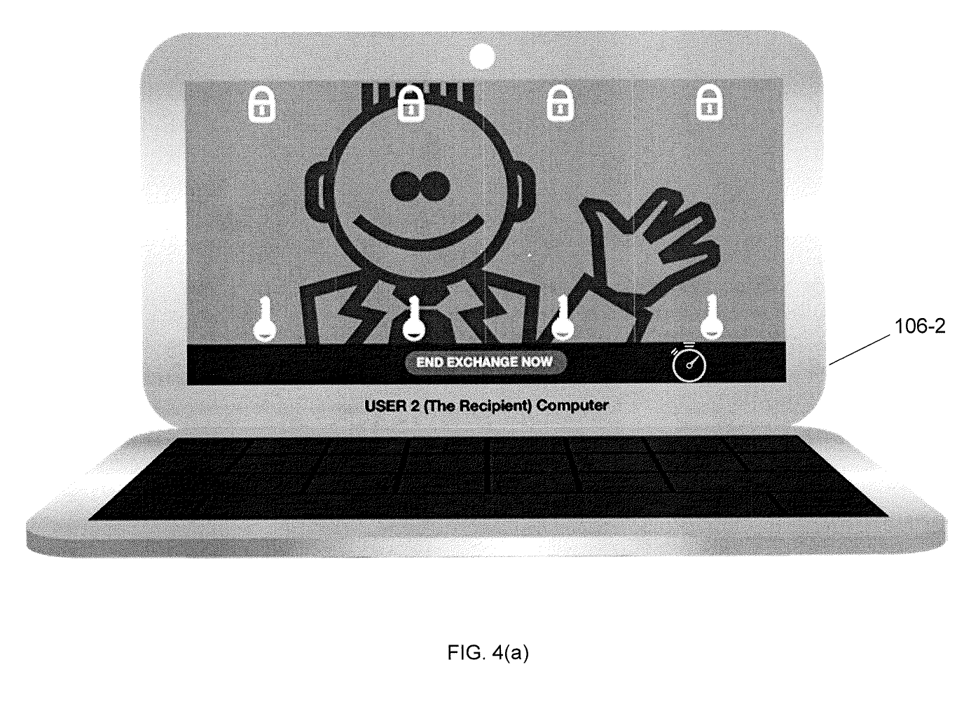

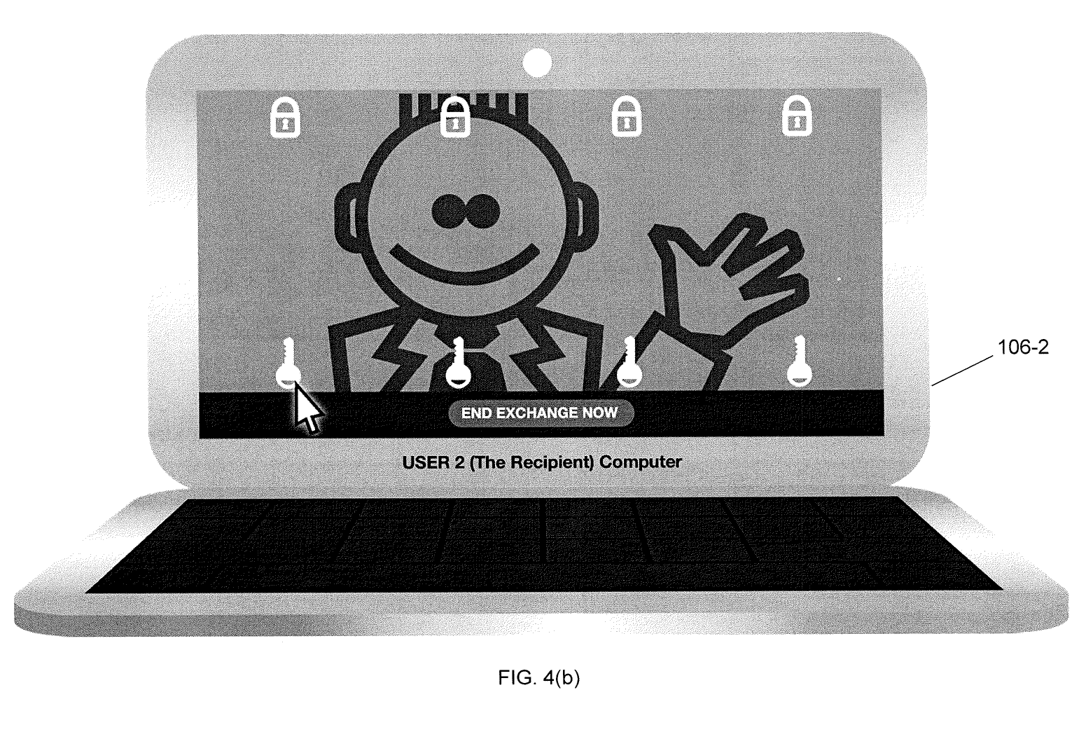

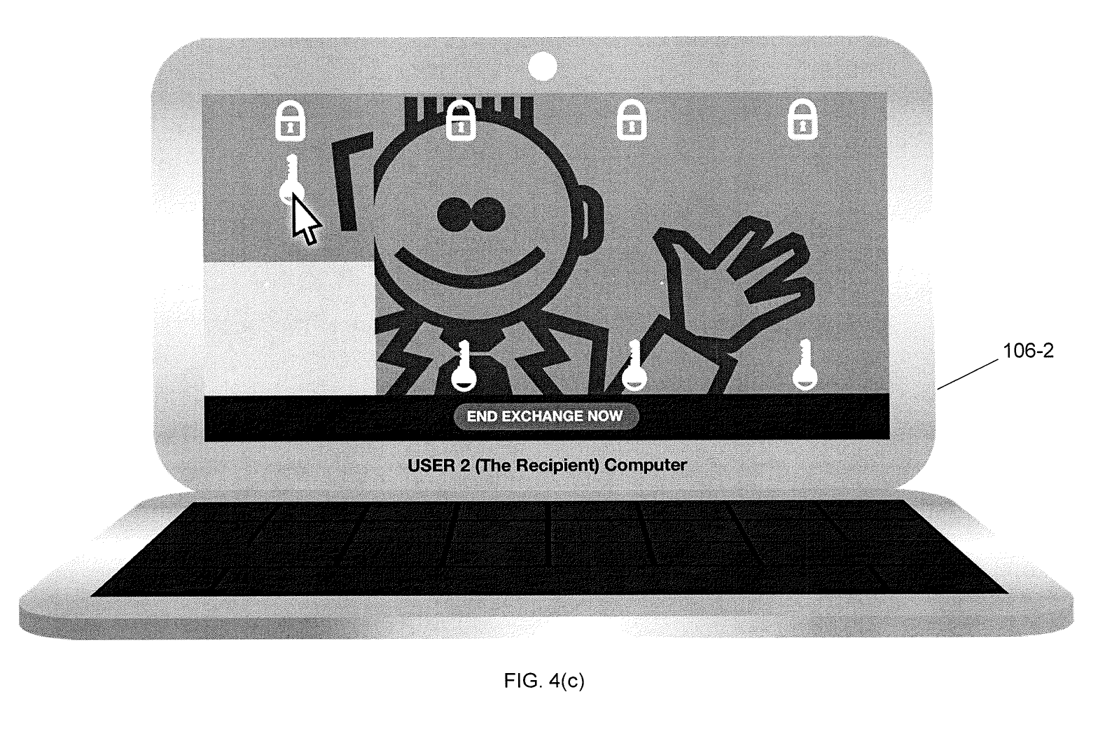

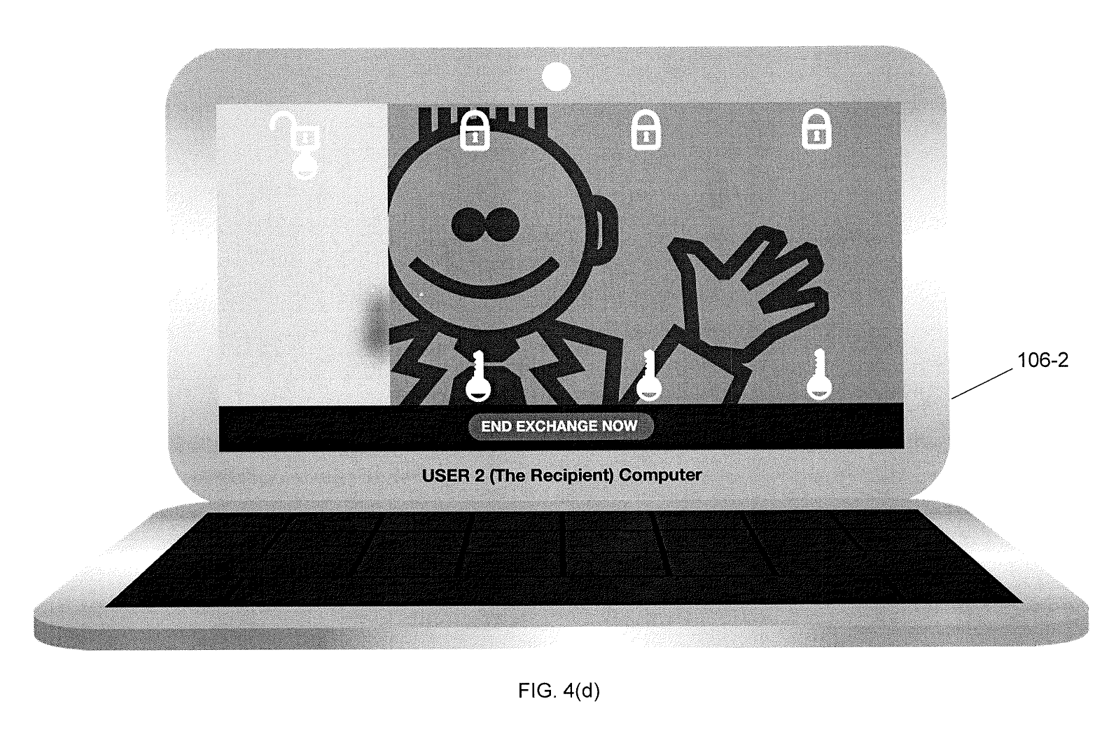

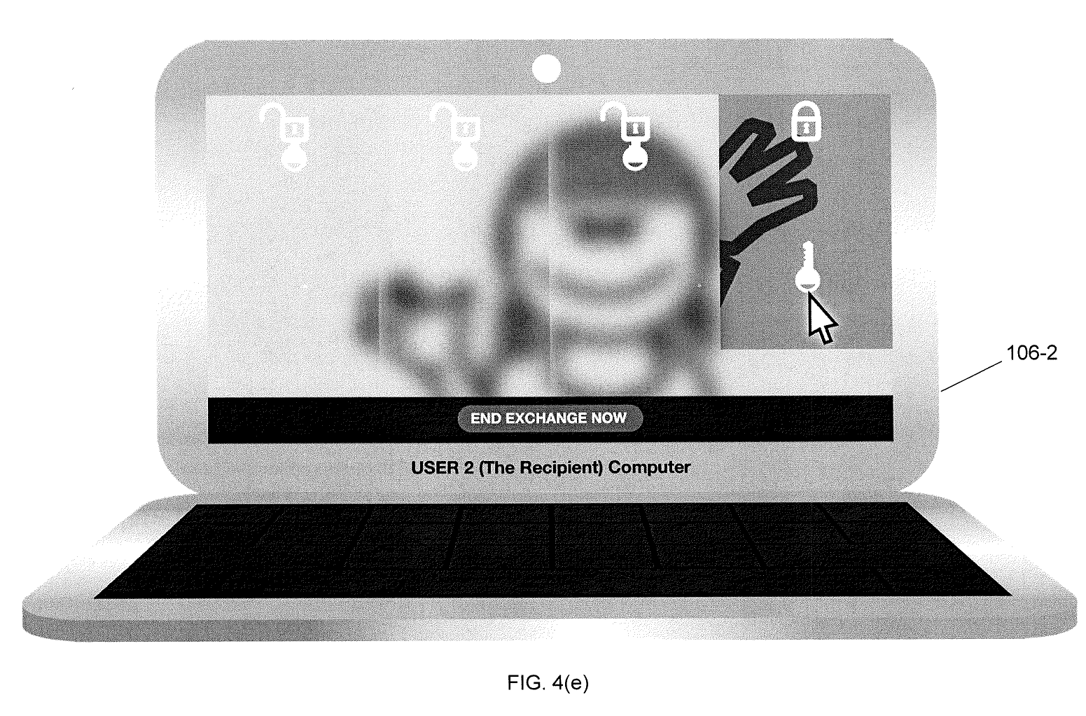

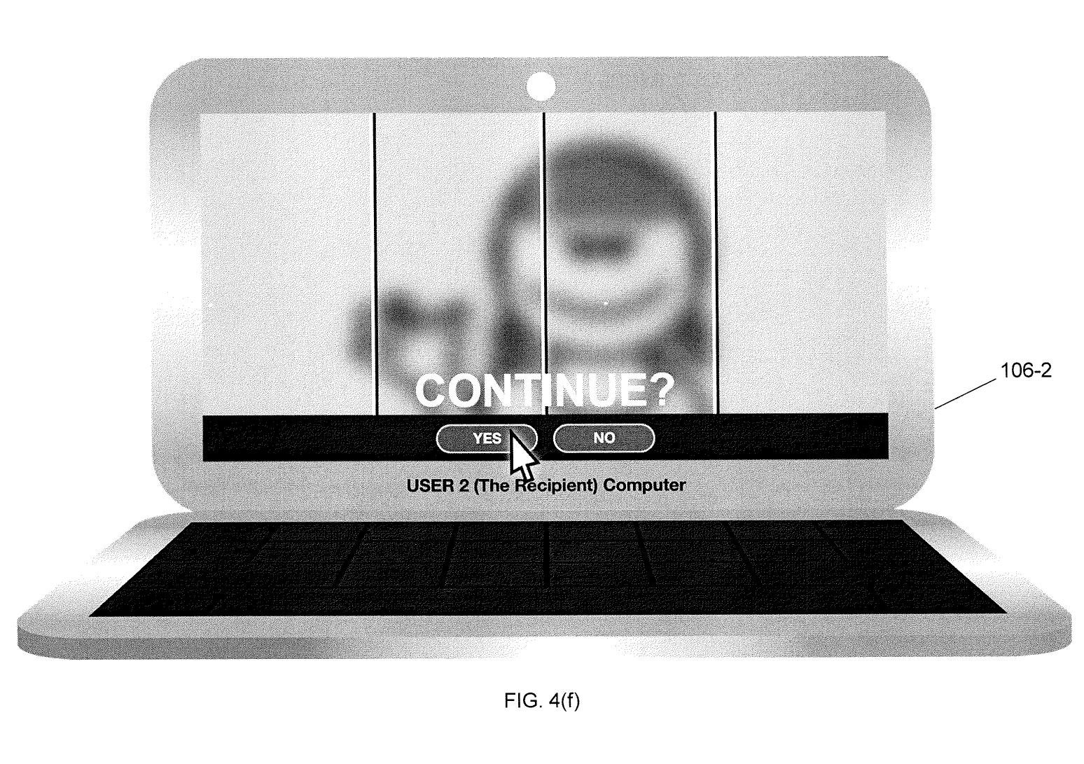

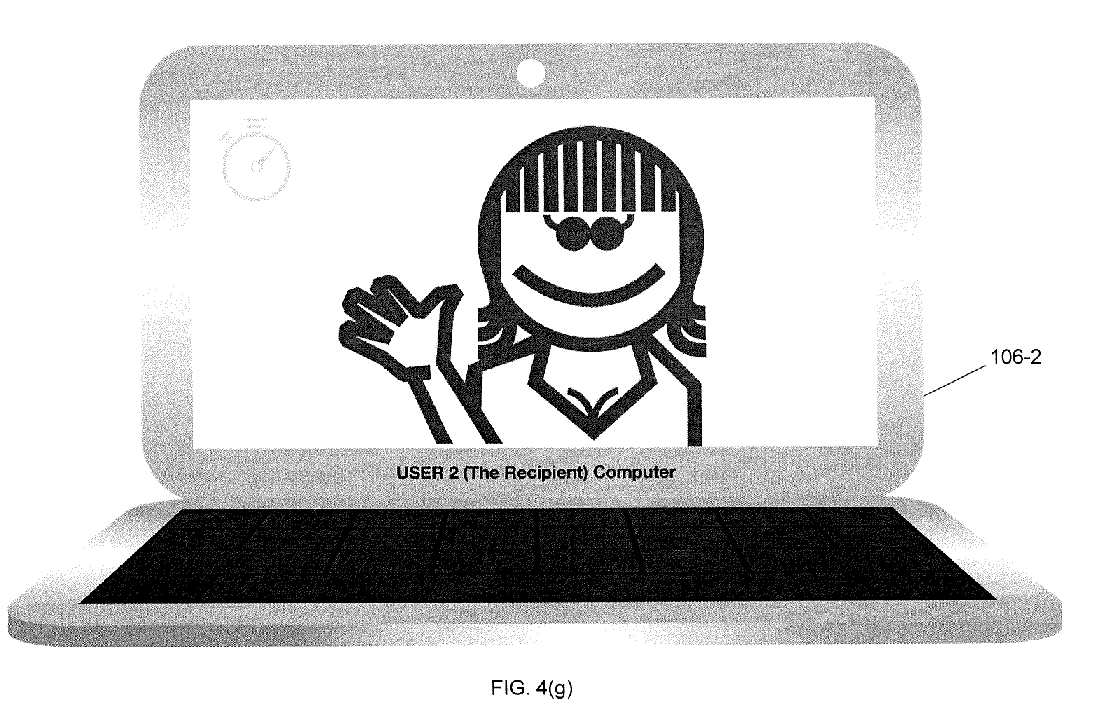

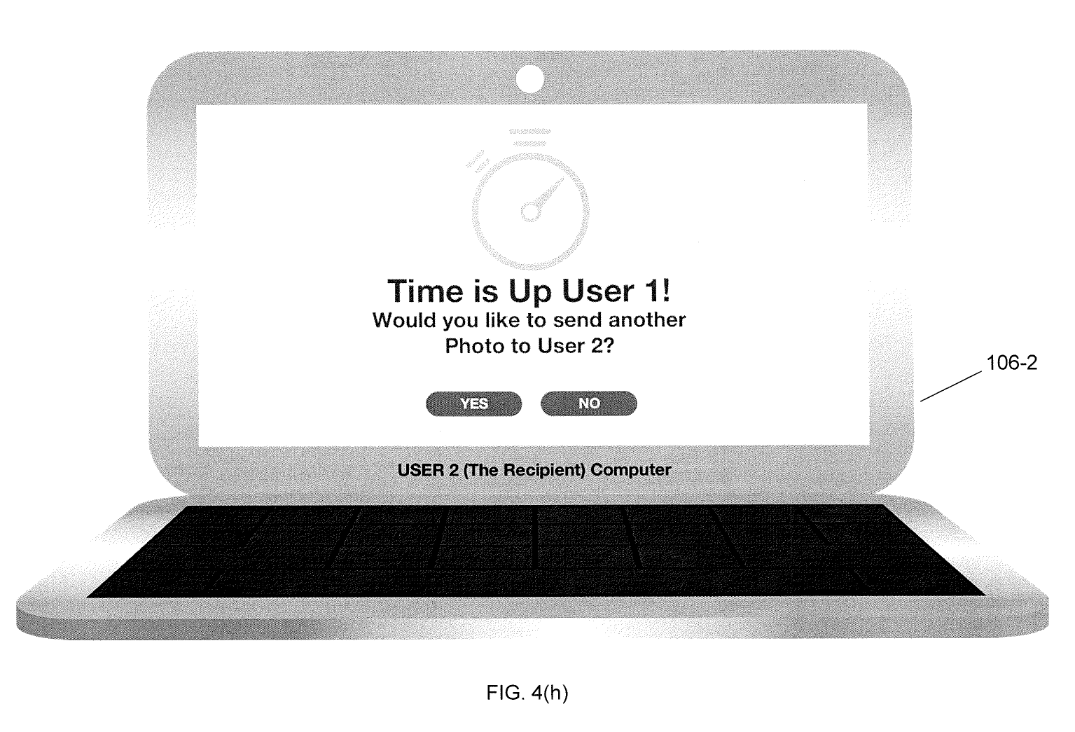

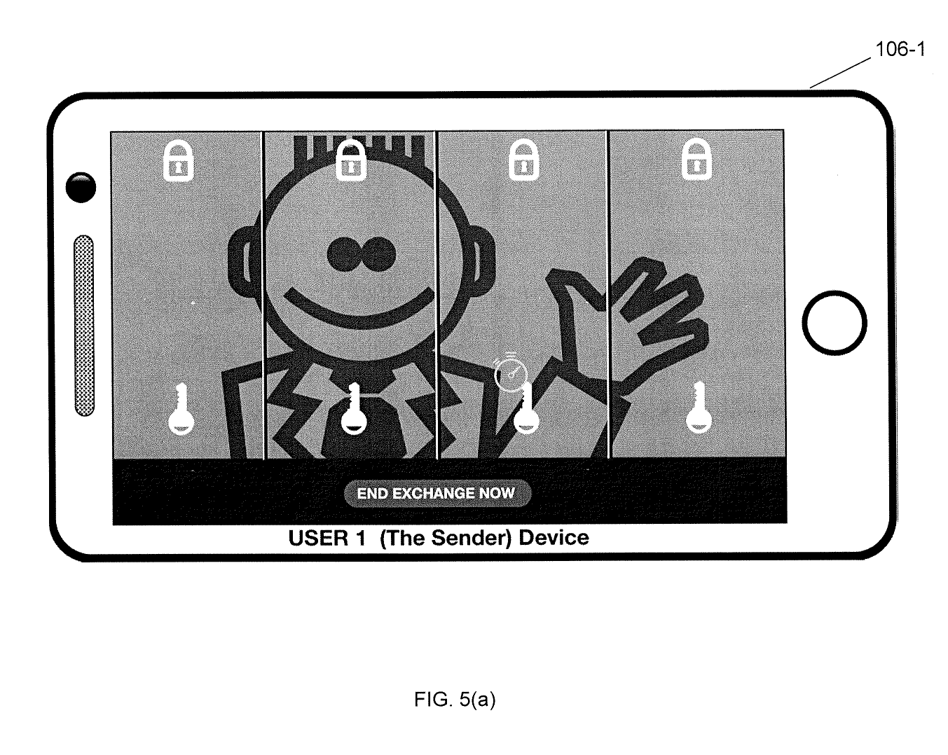

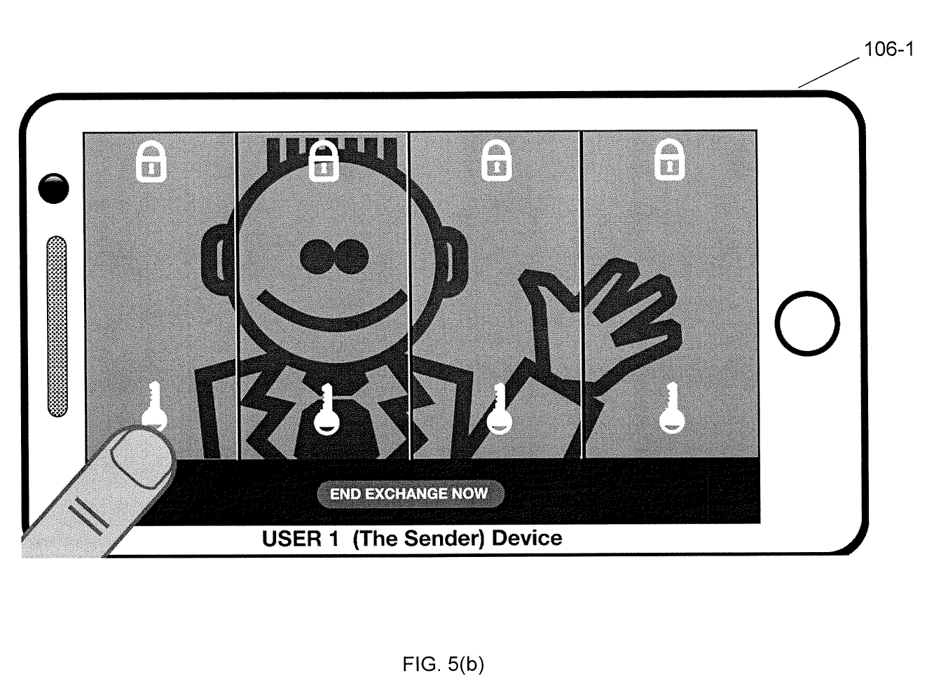

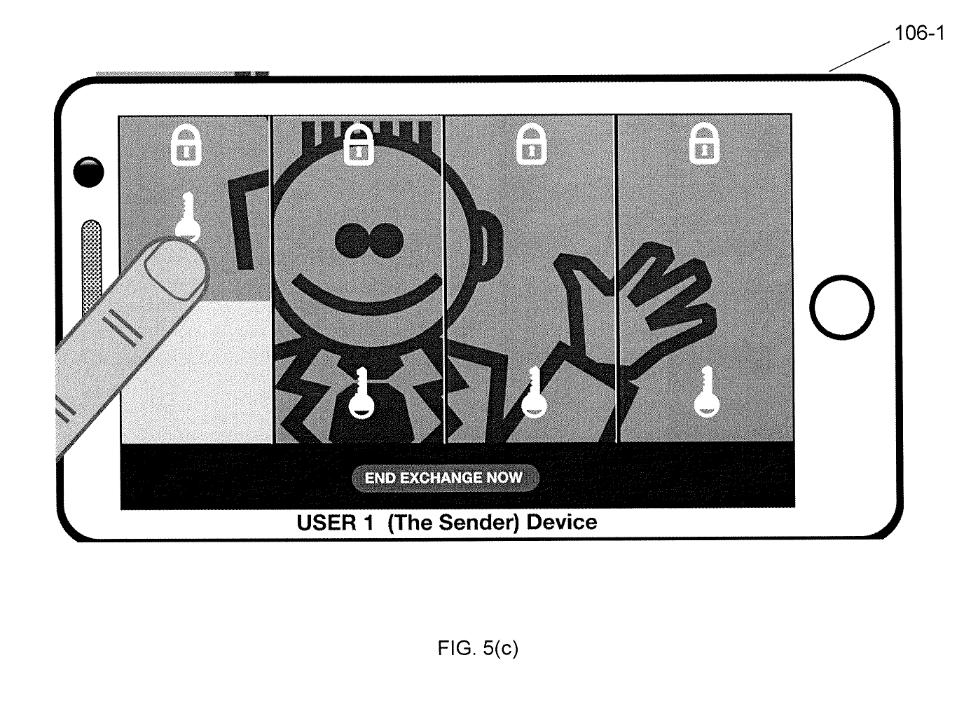

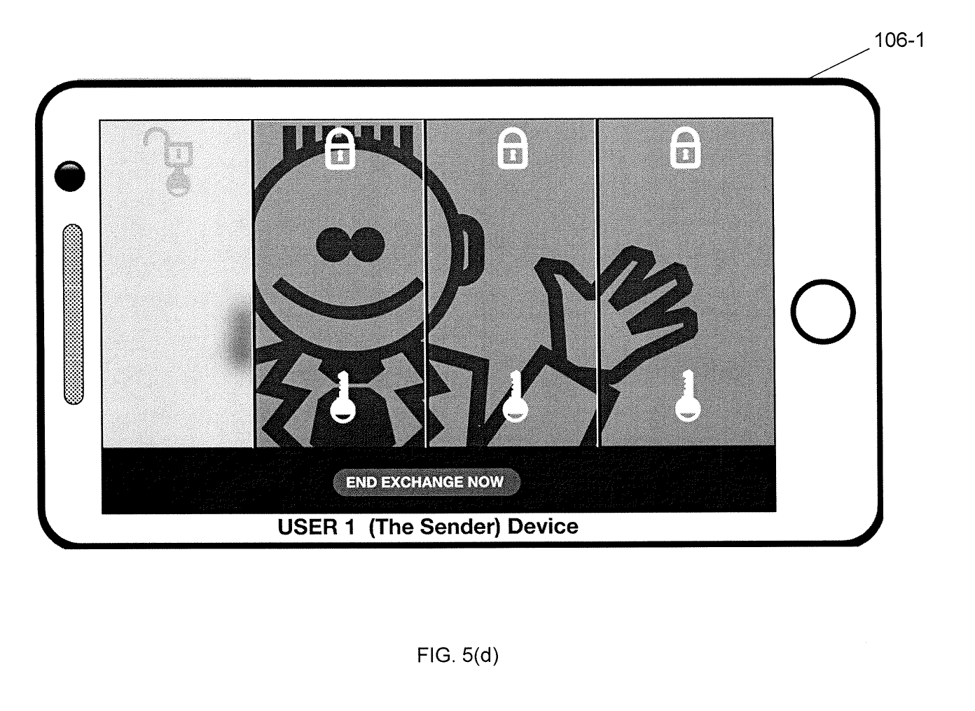

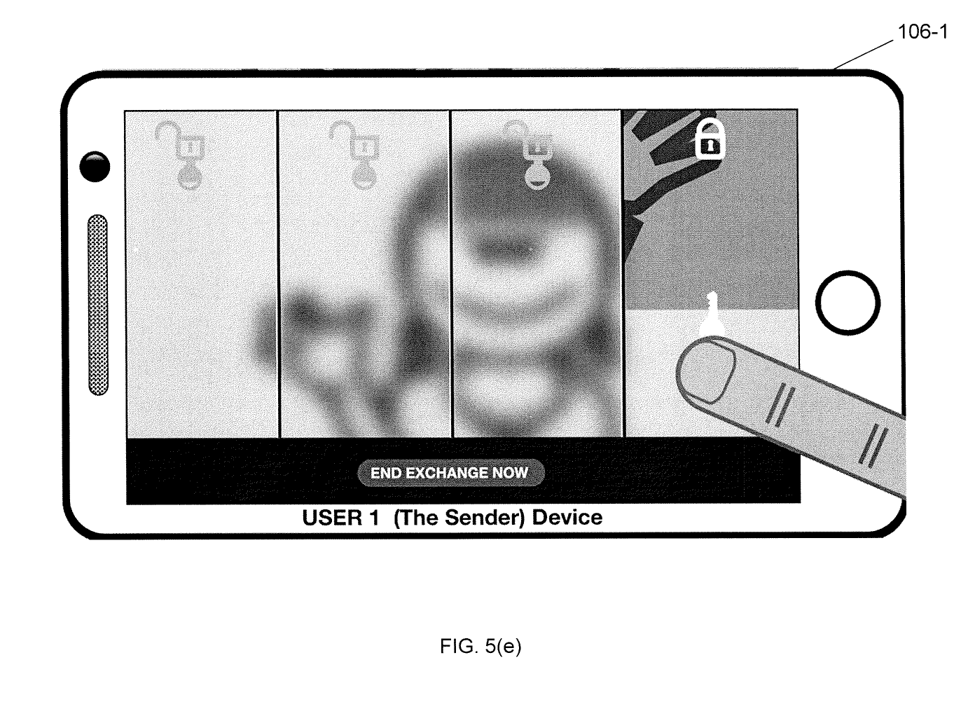

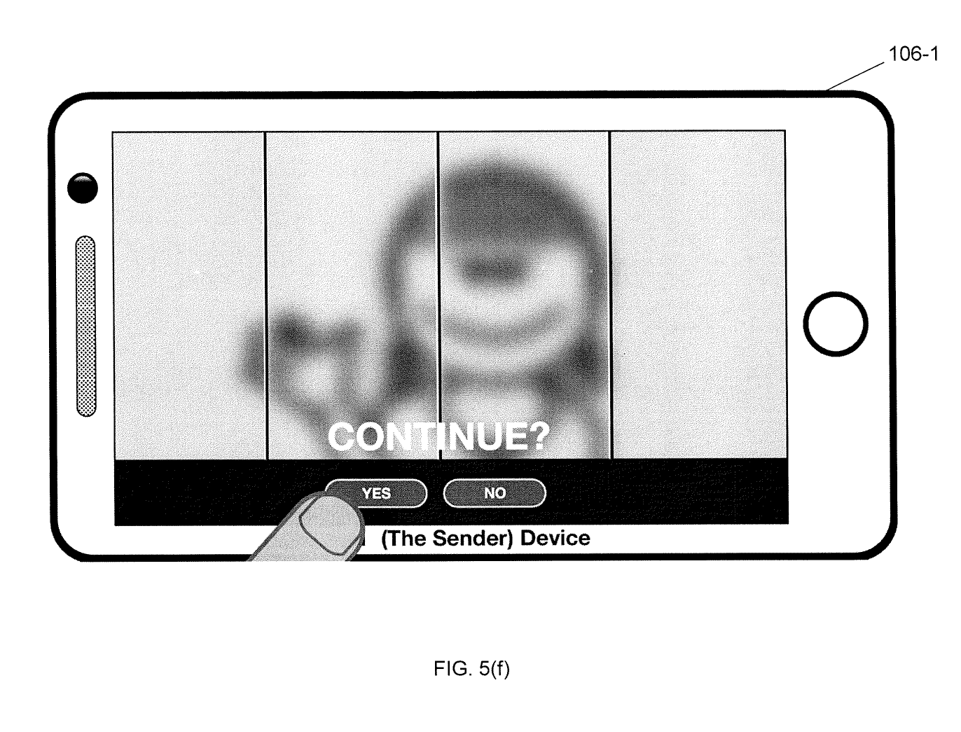

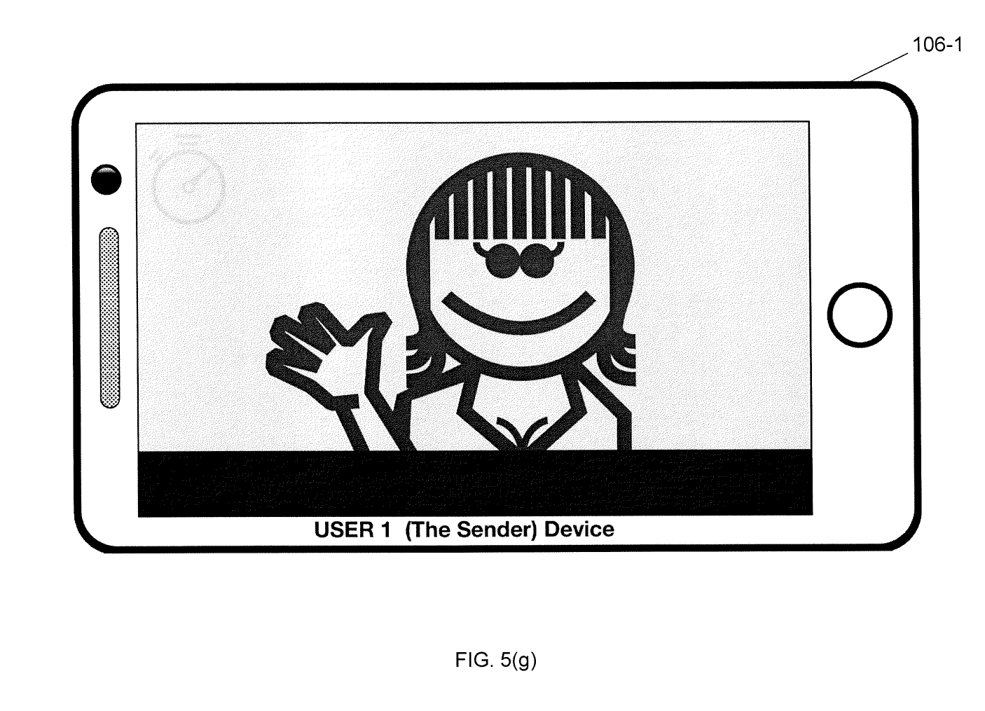

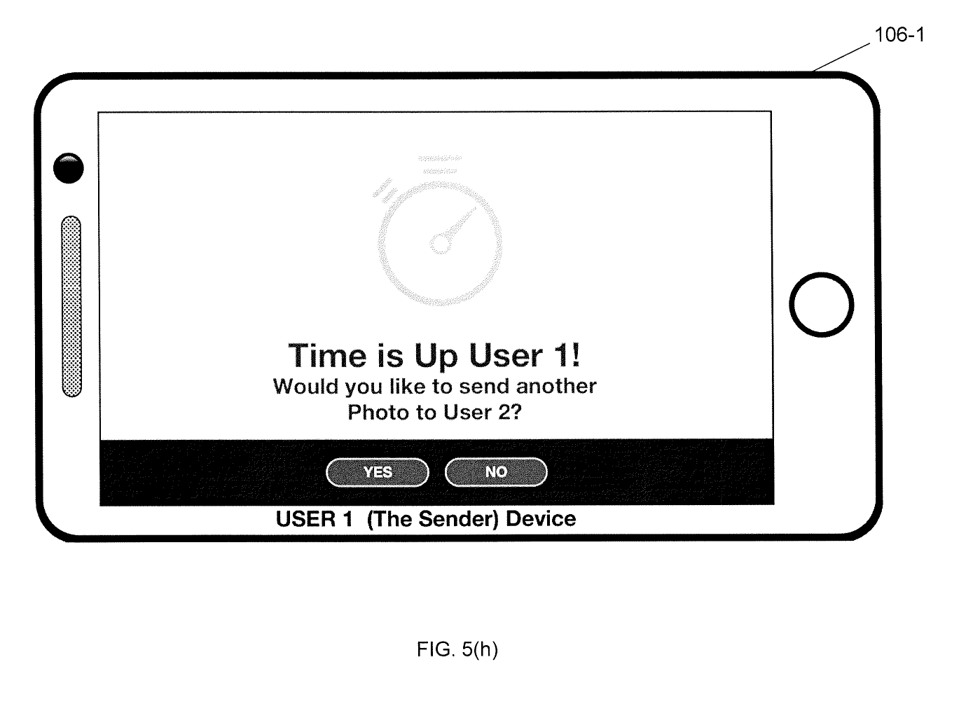

FIGS. 4(a) to 4(h) illustrate a set of exemplary displays on the second user device 106-2 in accordance with an embodiment of the disclosed subject matter, where the second user device 106-2 is a computer. FIGS. 4(a) to 4(h) are substantially similar with that of FIGS. 3(a) to 3(h), respectively. Furthermore, FIGS. 5(a) to 5(h) illustrate a set of exemplary displays on a first user device 106-1 in accordance with another embodiment of the disclosed subject matter, where the first user device 106-1 is a cellular phone and the displays are in a landscape orientation. FIGS. 5(a) to 5(h) are substantially similar with that of FIGS. 3(a) to 3(h), respectively.

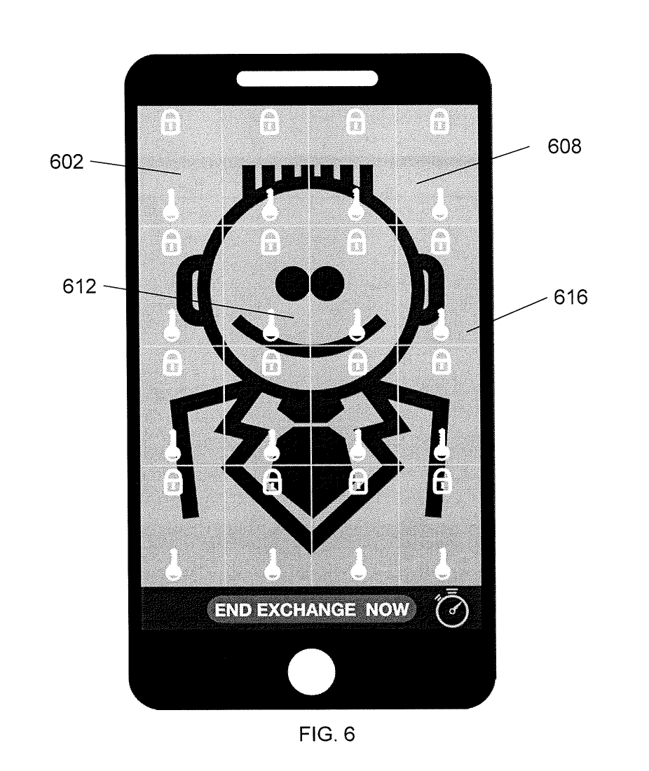

FIG. 6 illustrates an exemplary display on a user device in accordance with an embodiment of the disclosed subject matter, where a plurality of fragments are arranged in a grid pattern. Fragments 602, 608, 612, and 616 are four of the 16 fragments in FIG. 6. Specifically, FIG. 6 illustrates the grid pattern in a 4-fragment by 4-fragment arrangement. Either the user or the sever 104 can choose another arrangement of a grid pattern, such as 3-fragment by 3-fragment, 3-fragment by 4-fragment, 4-fragment by 3-fragment, or any other suitable X-fragment by Y-fragment arrangement.

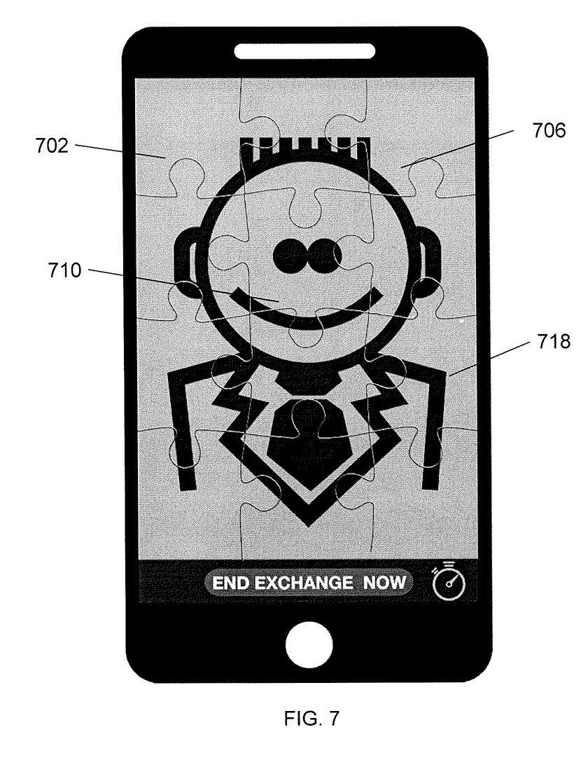

FIG. 7 illustrates an exemplary display on a user device in accordance with an embodiment of the disclosed subject matter, where a plurality of fragments are arranged in an interlocking or puzzle pattern. Fragments 702, 706, 710, and 718 are four of the 12 fragments in FIG. 7. Although FIG. 7 illustrates 12 puzzle pieces in a 4-fragment by 3-fragment arrangement, either the user or the sever 104 can choose other suitable numbers of puzzle pieces and/or other suitable ways of arrangement.

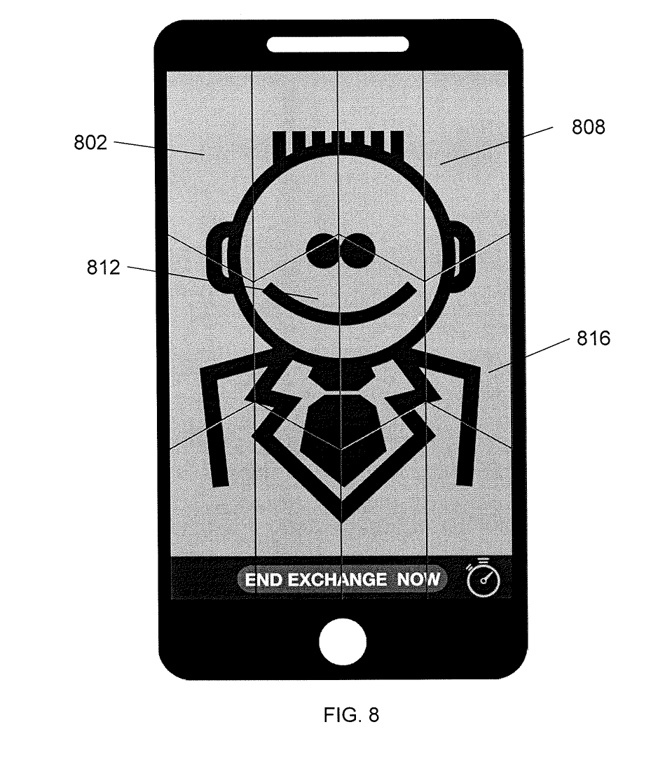

FIG. 8 illustrates an exemplary display on a user device in accordance with an embodiment of the disclosed subject matter, where a plurality of fragments are arranged in a geometric pattern. Fragments 802, 808, 812, and 816 are four of the 12 fragments in FIG. 8. The disclosed subject matter includes any other suitable geometric patterns.

FIGS. 9(a) to 9(j) illustrate a set of exemplary displays of obscured digital content with different obscuring methods. The examples illustrated by FIGS. 9(a) to 9(j) are non-limiting, and other suitable obscuring methods generally known in the art can also be used. Specifically, FIG. 9(a) illustrates an exemplary obscured digital content by fully blacking out the original digital content. FIG. 9(b) illustrates an exemplary obscured digital content by partially blacking out the original digital content. FIG. 9(c) illustrates an exemplary obscured digital content by graying out the original digital content. FIG. 9(d) illustrates an exemplary obscured digital content through pixelation, which includes lowering the resolution of one or more pixels of the original digital content. FIG. 9(e) illustrates an exemplary obscured digital content by blending the original digital content with another digital content. FIG. 9(f) illustrates an exemplary obscured digital content by overlaying the original digital content with another digital content. FIG. 9(g) illustrates an exemplary obscured digital content by adding monochromatic noise to the original digital content. FIG. 9(h) illustrates an exemplary obscured digital content by adding a ripple effect to the original digital content. FIG. 9(i) illustrates an exemplary obscured digital content by adding a twirl effect to the original digital content. FIG. 9(j) illustrates an exemplary obscured digital content by increasing the brightness of the original digital content.

The disclosed subject matters do not limit the digital content sharing process between two users. In some embodiments, one or more users can initiate the digital content sharing process with one or more others users: each user will take a turn to select a fragment to be revealed from all of the digital content being shared, and all users continue revealing fragments until all fragments are revealed.

The disclosed subject matters do not limit the digital content sharing process to bilateral sharing. In some embodiments, a sending party, which can include one or more users, can select to unilaterally share digital content with a recipient party, which can also include one or more users. The recipient party can receive the digital content sent by the sending party with the digital content being overlaid by a plurality of fragments. The sending party may also indicate how often one fragment can be removed by the recipient party to reveal the underlying portion of the digital content, which can be either in an obscured format or an unobscured format. In some embodiments, the sending party may select to automatically remove one fragment for every given period, which can be predetermined by the sending party or the server 104.

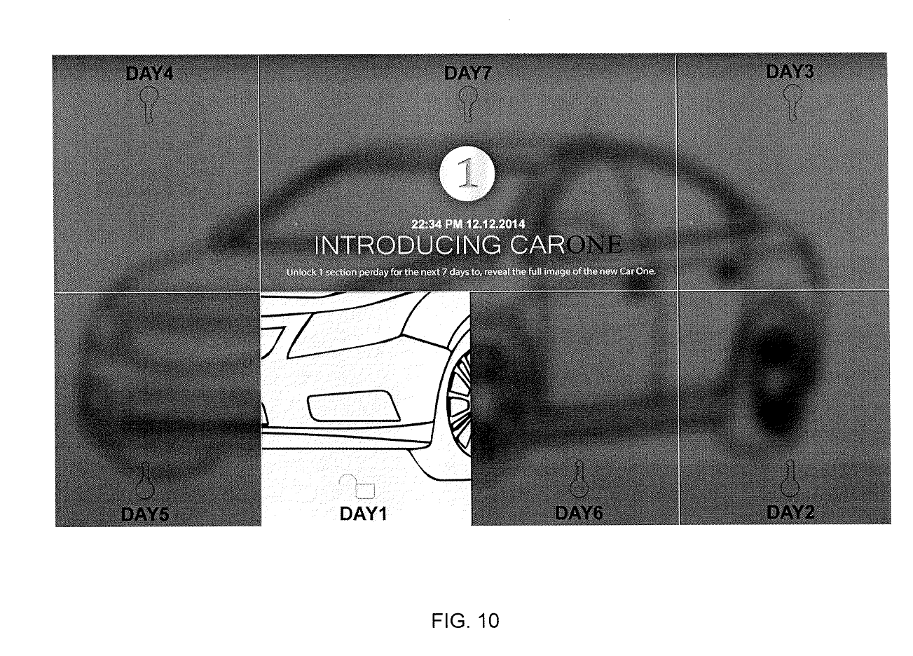

FIG. 10 illustrates an exemplary unilateral sharing process on a user device in accordance with an embodiment of the disclosed subject matter. In this embodiment, a car company unilaterally shares its new car model with a group of users, where the group of users can be selected based on some predetermined lists, geological location, other selection criteria, or random selections. Each of the group of users receives the image of the new car model covered by seven (or other suitable number of) fragments, where the image of the new car can model be either in an obscured format or an unobscured formant. Each of the group of users can reveal and/or view one fragment per day until all fragments are revealed. If the underlying image is in the obscured format, it can be converted to the unobscured format after all fragments are revealed. The car company can determine whether or not a given user is interested in the new car model based on the user's interest/activity in revealing the fragments. If a user timely reveals one fragment every day, then the user may be interested in the new car model. On the other hand, if a user does not reveal the fragments or does not reveal the fragments timely, then the user may not be interested in the new car model. In some embodiments, the sending party can select to have fragments automatically revealed based on some revealing frequency, where the revealing frequency can be selected by the sending party or randomly selected by the server 104.

The disclosed subject matters do not limit the digital content sharing process to image sharing. Other types of digital content including, without limitation, video, streaming video, documents, or photographs, can also be shared in fragments. In some embodiments, a plurality of fragments can overlay one or more video frames or running video, and users can reveal the fragments in turn. In some embodiments, video can be obscured through any suitable obscuring method or combination of methods, including, without limitation, blurring, pixelation, blacking out, graying out, blending, overlaying with another image, changing opacity level, adding noise, adding obscuring effect, changing brightness, or other suitable obscuring method.

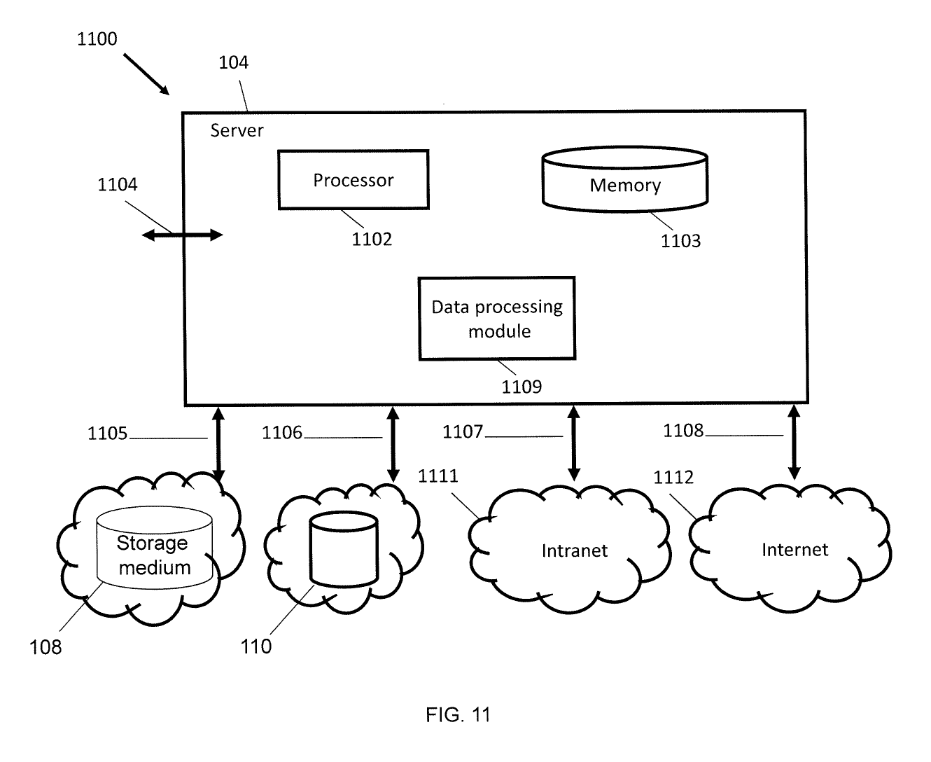

FIG. 11 is a block diagram of a server in accordance with certain embodiments of the disclosed subject matter. The block diagram 1100 shows the server 104, which includes a processor 1102, a memory 1103, interfaces 1104-1108, a data processing module 1109, a local network storage 108, a remote network storage 110, an Intranet 1111, and the Internet 1112. The server 104 can communicate with user device devices 106 (not shown) via the interface 1104; the server 104 can communicate with the local network storage medium 108 via the interface 1105; the server 104 can communicate with the remote network storage medium 110 via the interface 1106; the server 104 can communicate with the Intranet 511 via the interface 1107; and the server 104 can communicate with the Internet 512 via the interface 1108. The interfaces 1104-1108 are shown as separate interfaces but may be the same physical interface.

The data processing module 1109 can be configured to (a) receive a first digital content from a first user device 106-1 and a second digital content from a second user device 106-2; (b) generate a first digital content packet comprising: obscuring the first digital content to generate a first obscured digital content, and overlaying a screen comprising a first plurality of fragments on top of the first obscured digital content; (c) generate a second digital content packet comprising: obscuring the second digital content to generate a second obscured digital content, and overlaying a screen comprising a second plurality of fragments on top of the second obscured digital content; (d) send the first digital content packet to the second user device 106-2 and the second digital content packet to the first user device 106-1; (e) receive a selection of at least one fragment from the first plurality of fragments from the second user device 106-2 or the second plurality of fragments from the first user device 106-1, and in response: if the selection of the at least one fragment is from the first plurality of fragments from the second user device 106-2, update the first digital content packet by removing the selected at least one fragment from the first plurality of fragments to reveal at least one underlying portion of the first obscured digital content and the second digital content packet by removing at least one counterpart fragment from the second plurality of fragments to reveal at least one underlying portion of the second obscured digital content, and if the selection of the at least one fragment is from the second plurality of fragments from the first user device 106-1, update the second digital content packet by removing the selected at least one fragment from the second plurality of fragments to reveal at least one underlying portion of the second obscured digital content and the first digital content packet by removing at least one counterpart fragment from the first plurality of fragments to reveal at least one underlying portion of the first obscured digital content; (f) send the updated first digital content packet to the second user device 106-2 and the updated second digital content packet to the first user device 106-1; (g) repeat steps (e) to (f) until all of the first plurality of fragments and all of the second plurality of fragments are removed; and (h) send the first digital content to the second user device 106-2 and the second digital content to the first user device 106-1.

In some embodiments, the data processing module 1109 can be further configured to receive a request from the first user device 106-1 or the second user device 106-2 to terminate the sharing of digital contents during at least one of steps (a) to (h); and in response, prevent from sending (1) any of the first digital content packet, the updated first digital content packet, and the first digital content to the second user device 106-2, and (2) any of the second digital content packet, the updated second digital content packer, and the second digital content to the first user device 106-1.

In some embodiments, the data processing module 1109 that is configured to repeat step (e) can be further configured to: if the selection of the at least one fragment is from the first plurality of fragments from the second user device 106-2, receive the at least one counterpart fragment from the second plurality of fragments from the first user device 106-1, and if the selection of the at least one fragment is from the second plurality of fragments from the first user device 106-1, receive the at least one counterpart fragment from the first plurality of fragments from the second user device 106-2.

In some embodiments, the data processing module 1109 can be further configured to receive a digital content expiration time from the first user device 106-1 or the second user device 106-2; and recall the first digital content from the second user device 106-2 and the second digital content from the first user device 106-1 when the digital content expiration time is reached.

In some embodiments, the data processing module 1109 can reside in a user device (e.g., the first user device 106-1) and can be configured to (a) receive a first digital content; (b) generate a first digital content packet, wherein the first digital content packet comprises: a first obscured digital content that obscures the first digital content, and a first screen comprising a first plurality of fragments, wherein the first screen overlays on top of the first obscured digital content; (c) send the first digital content packet to the server 104 or; (d) receive a second digital content packet from the server 104, wherein the second digital content packet comprises: a second obscured digital content by obscuring the second digital content, and a second screen comprising a second plurality of fragments, wherein the second screen overlays on top of the second obscured digital content; (e) receive a selection of at least one fragment from the first plurality of fragments from the server 104 or the second plurality of fragments from the first user device 106-1, and in response: if the selection of the at least one fragment is from the first plurality of fragments from the server 104, update the second digital content packet by removing at least one counterpart fragment from the second plurality of fragments to reveal at least one underlying portion of the second obscured digital content, and if the selection of the at least one fragment is from the second plurality of fragments from the first user device 106-1, update the second digital content packet by removing the selected at least one fragment from the second plurality of fragments to reveal at least one underlying portion of the second obscured digital content; (f) repeat step (e) until all of the second plurality of fragments are removed; (g) send the first digital content to the server 104; and (h) receive the second digital content from the server 104.

In some embodiments, the data processing module 1109 can reside in a user device (e.g., the first user device 106-1) and can be configured to (a) receive a selection of a first digital content; (b) send the first digital content to the server 104 or the second user device 106-2; (c) receive a second digital content from the server 104 or the second user device 106-2; (d) generate and display a second digital content packet comprising: a second obscured digital content that obscures the second digital content, and a screen comprising a second plurality of fragments, wherein the screen overlays on top of the second obscured digital content; (e) receive a selection of at least one fragment from (1) a first plurality of fragments associated with the first digital content from the server 104 or the second user device 106-2, or (2) the second plurality of fragments, and in response: if the selection of the at least one fragment is from the first plurality of fragments from the server 104 or the second user device 106-2, update the second digital content packet by removing at least one counterpart fragment from the second plurality of fragments to reveal at least one underlying portion of the second obscured digital content, and if the selection of the at least one fragment is from the second plurality of fragments, update the second digital content packet by removing the selected at least one fragment from the second plurality of fragments to reveal at least one underlying portion of the second obscured digital content; (f) repeat step (e) until (1) all of the second plurality of fragments are removed and (2) an indication is received from the server 104 or the second user device 106-2 that all of the first plurality of fragments are removed; and (g) reveal the second digital content.

In some embodiments, the data processing module 1109 can reside in a user device (e.g., the first user device 106-1) and can be further configured to receive a request from the first user device 106-1, the server 104, or the second user device 106-2 to terminate the sharing of digital content during at least one of steps (a) to (g); and in response, (1) prevent from sending the first digital content to the second user device or the server, and (2) delete the second digital content.

In some embodiments, the data processing module 1109 can reside in a user device (e.g., the first user device 106-1). The data processing module 1109 that is configured to repeat step (e) can be further configured to: if the selection of the at least one fragment is from the second plurality of fragments, send the selection of the at least one fragment from the second plurality of fragments to the server 104 or the second user device 106-2.

In some embodiments, the data processing module 1109 can reside in a user device (e.g., the first user device 106-1) and can be further configured to receive a digital content expiration time from the first user device 106-1, the server 104, or the second user device 106-2; and recall the first digital content from the second user device 106-2 and the second digital content from the first user device 106-1 when the digital content expiration time is reached.

The data processing module 1109 can be implemented in software using the memory 1103. The memory 1103 can be a non-transitory computer readable medium, flash memory, a magnetic disk drive, an optical drive, a PROM, a ROM, or any other memory or combination of memories. The software can run on a processor 1102 capable of executing computer instructions or computer code. The processor 1102 might also be implemented in hardware using an application specific integrated circuit (ASIC), programmable logic array (PLA), field programmable gate array (FPGA), or any other integrated circuit.

FIG. 11 shows the server 104 having data processing module 1109 that performs the above-described operations in accordance with certain embodiments of the disclosed subject matter. The server 104 may include additional modules, less modules, or any other suitable combination of modules that perform any suitable operation or combination of operations.

The interfaces 1104-1108 provide an input and/or output mechanism to communicate over a network. The interfaces 1104-1108 enable communication with user devices, as well as other network nodes in the communication network 102. The interfaces 1104-1108 can be implemented in hardware to send and receive signals in a variety of mediums, such as optical, copper, and wireless, and in a number of different protocols some of which may be non-transient.

The server 104 can operate using an operating system (OS) software. In some embodiments, the OS software is based on a Linux software kernel and runs specific applications in the server such as monitoring tasks and providing protocol stacks. The OS software allows server resources to be allocated separately for control and data paths. For example, certain packet accelerator cards and packet services cards are dedicated to performing routing or security control functions, while other packet accelerator cards/packet services cards are dedicated to processing user session traffic. As network requirements change, hardware resources can be dynamically deployed to meet the requirements in some embodiments.

In some embodiments, the server 104 can reside in a data center and form a node in a cloud computing infrastructure. The server 104 can also provide services on demand. A module hosting a user device is capable of migrating from one server to another server seamlessly, without causing program faults or system breakdown. The server 104 on the cloud can be managed using a management system.

The user device 106 can include user equipment. The user equipment communicates with one or more radio access networks and with wired communication networks. The user equipment can be a cellular phone having phonetic communication capabilities. The user equipment can also be a smart phone providing services such as word processing, web browsing, gaming, e-book capabilities, an operating system, and a full keyboard. The user equipment can also be a tablet computer providing network access and most of the services provided by a smart phone. The user equipment operates using an operating system such as Symbian OS, iPhone OS, RIM's Blackberry, Windows Mobile, Linux, HP WebOS, and Android. The screen might be a touch screen that is used to input data to the mobile device, in which case the screen can be used instead of the full keyboard. The user equipment can also keep global positioning coordinates, profile information, or other location information.

The user device 106 also includes any platforms capable of computations and communication. Non-limiting examples can include televisions (TVs), video projectors, set-top boxes or set-top units, digital video recorders (DVR), computers, netbooks, laptops, and any other audio/visual equipment with computation capabilities. The user device 106 is configured with one or more processors that process instructions and run software that may be stored in memory. The processor also communicates with the memory and interfaces to communicate with other devices. The processor can be any applicable processor such as a system-on-a-chip that combines a CPU, an application processor, and flash memory. The user device 106 can also provide a variety of user interfaces such as a keyboard, a touch screen, a trackball, a touch pad, and/or a mouse. The user device 106 may also include speakers and a display device in some embodiments.

In some embodiments of the disclosed subject matters, the server 104 can reside in the first user device 106-1 or the second user device 106-2. In some embodiments, the data processing module 1109 can reside in the first user device 106-1 or the second user device 106-2. In some embodiments, the first user device 106-1 and/or the second user device 106-2 can have separate data processing modules that are similar to the data processing module 1109. Throughout the disclosed subject matters, any function that is handled by the server 104 can also be handled by the first user device 106-1, the second user device 106-2, or any suitable combination of the server 104, the first user device 106-1, or the second user device 106-2. Throughout the disclosed subject matters, any function that is handled by the first user device 106-1 can also be handled by the server 104, the second user device 106-2, or any suitable combination of the server 104, the first user device 106-1, or the second user device 106-2. Throughout the disclosed subject matters, any function that is handled by the second user device 106-2 can also be handled by the server 104, the first user device 106-1, or any suitable combination of the server 104, the first user device 106-1, or the second user device 106-2.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, systems, methods and media for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter, which is limited only by the claims which follow.

What is claimed is:

1. A method for sharing digital content in fragments, comprising:
(a) receiving, at a first user device, a selection of a first digital content;
(b) sending, at the first user device, the first digital content to a server or a second user device;
(c) receiving, at the first user device, from the server or the second user device, a second digital content;
(d) generating and displaying, at the first user device, a second digital content packet comprising:
obscuring the second digital content to generate a second obscured digital content, and
overlaying a screen comprising a second plurality of fragments, wherein the screen overlays on top of the second obscured digital content;
(e) receiving, at the first user device, a selection of at least one fragment from (1) a first plurality of fragments associated with the first digital content from the server or the second user device, or (2) the second plurality of fragments, and in response:
if the selection of the at least one fragment is from the first plurality of fragments from the server or the second user device, updating, at the first user device, the second digital content packet by removing at least one counterpart fragment from the second plurality of fragments to reveal at least one underlying portion of the second obscured digital content, and
if the selection of the at least one fragment is from the second plurality of fragments, updating, at the first user device, the second digital content packet by removing the selected at least one fragment from the second plurality of fragments to reveal at least one underlying portion of the second obscured digital content;
(f) repeating, at the first user device, step (e) until all of the second plurality of fragments are removed and the first user device receives an indication from the server or the second user device that all of the first plurality of fragments are removed; and
(g) revealing the second digital content.

2. The method of claim 1, further comprising:
receiving, at the first device, a request from the first user device, the server, or the second user device to terminate the sharing of digital content during at least one of steps (a) to (g); and
in response, (1) preventing, at the first user device, from sending the first digital content to the second user device or the server, and (2) deleting, at the first user device, the second digital content.

3. The method of claim 1, where repeating, at the first user device, step (e), further comprises:
if the selection of the at least one fragment is from the second plurality of fragments, sending, at the first user device, the selection of the at least one fragment from the second plurality of fragments to the server or the second user device.

4. The method of claim 1, wherein the first plurality of fragments and the second plurality of fragments have a same number of fragments.

5. The method of claim 4, wherein the first plurality of fragments and the second plurality of fragments have a same arrangement of fragments.

6. The method of claim 5, wherein the selected at least one fragment and the at least one counterpart fragment have symmetric locations.

7. The method of claim 1, wherein the first plurality of fragments and the second plurality of fragments are arranged in at least one of adjacent rectangles, a grid pattern, an interlocking pattern, and a geometric pattern.

8. The method of claim 1, wherein obscuring the first digital content and obscuring the second digital content comprise at least one of blurring, pixelation, blacking out, graying out, blending, and overlaying with another digital content.

9. The method of claim 1, further comprising:
receiving, at the first user device, a digital content expiration time from the first user device, the server, or the second user device; and
deleting, at the first user device, the second digital content from the first user device when the digital content expiration time is reached.

10. An apparatus for sharing digital content in fragments, comprising:
a memory that stores a data processing module; and
a processor configured to run the data processing module stored in the memory that is configured to:
(a) receive a selection of a first digital content;
(b) send the first digital content to a server or a second user device;
(c) receive a second digital content from the server or the second user device;
(d) generate and display a second digital content packet comprising:
a second obscured digital content that obscures the second digital content, and
a screen comprising a second plurality of fragments, wherein the screen overlays on top of the second obscured digital content;
(e) receive a selection of at least one fragment from (1) a first plurality of fragments associated with the first digital content from the server or the second user device, or (2) the second plurality of fragments, and in response:
if the selection of the at least one fragment is from the first plurality of fragments from the server or the second user device, update the second digital content packet by removing at least one counterpart fragment from the second plurality of fragments to reveal at least one underlying portion of the second obscured digital content, and
if the selection of the at least one fragment is from the second plurality of fragments, update the second digital content packet by removing the selected at least one fragment from the second plurality of fragments to reveal at least one underlying portion of the second obscured digital content;
(f) repeat step (e) until (1) all of the second plurality of fragments are removed and (2) an indication is received from the server or the second user device that all of the first plurality of fragments are removed; and
(g) reveal the second digital content.

11. The apparatus of claim 10, wherein the data processing module is further configured to:
receive a request from the first user device or the second user device to terminate the sharing of digital content during at least one of steps (a) to (g); and
in response, (1) prevent from sending the first digital content to the second user device or the server, and (2) delete the second digital content.

12. The apparatus of claim 10, wherein the data processing module that is configured to repeat step (e) is further configured to:
if the selection of the at least one fragment is from the second plurality of fragments, send the selection of the at least one fragment from the second plurality of fragments to the server or the second user device.

13. The apparatus of claim 10, wherein the first plurality of fragments and the second plurality of fragments have a same number of fragments.

14. The apparatus of claim 13, wherein the first plurality of fragments and the second plurality of fragments have a same arrangement of fragments.

15. The apparatus of claim 14, wherein the selected at least one fragment and the at least one counterpart fragment have symmetric locations.

16. The apparatus of claim 10, wherein the first plurality of fragments and the second plurality of fragments are arranged in at least one of adjacent rectangles, a grid pattern, an interlocking pattern, and a geometric pattern.

17. The apparatus of claim 10, wherein obscuring the first digital content and obscuring the second digital content comprise at least one of blurring, pixelation, blacking out, graying out, blending, and overlaying with another digital content.

18. The apparatus of claim 10, wherein the data processing module is further configured to:
receive a digital content expiration time from the first user device, the server, or the second user device; and
delete the second digital content from the first user device when the digital content expiration time is reached.

19. A non-transitory computer readable medium having executable instructions operable to cause an apparatus to:
(a) receive a selection of a first digital content;
(b) send the first digital content to a server or a second user device;
(c) receive a second digital content from the server or the second user device;
(d) generate and display a second digital content packet comprising:
a second obscured digital content that obscures the second digital content, and
a screen comprising a second plurality of fragments, wherein the screen overlays on top of the second obscured digital content;
(e) receive a selection of at least one fragment from (1) a first plurality of fragments associated with the first digital content from the server or the second user device, or (2) the second plurality of fragments, and in response:
if the selection of the at least one fragment is from the first plurality of fragments from the server or the second user device, update the second digital content packet by removing at least one counterpart fragment from the second plurality of fragments to reveal at least one underlying portion of the second obscured digital content, and
if the selection of the at least one fragment is from the second plurality of fragments, update the second digital content packet by removing the selected at least one fragment from the second plurality of fragments to reveal at least one underlying portion of the second obscured digital content;
(f) repeat step (e) until (1) all of the second plurality of fragments are removed and (2) an indication is received from the server or the second user device that all of the first plurality of fragments are removed; and
(g) reveal the second digital content.

20. The non-transitory computer readable medium of claim 19, further comprising executable instructions operable to cause the apparatus to:
receive a digital content expiration time from the first user device, the server, or the second user device; and
delete the second digital content from the first user device when the digital content expiration time is reached.
